(19) United States
(12) Patent Application Publication
(10) Pub. No.: US 2012/0095767 A1
(43) Pub. Date: Apr. 19, 2012

(54) VOICE QUALITY CONVERSION DEVICE, METHOD OF MANUFACTURING THE VOICE QUALITY CONVERSION DEVICE, VOWEL INFORMATION GENERATION DEVICE, AND VOICE QUALITY CONVERSION SYSTEM

(76) Inventors: Yoshifumi HIROSE, Kyoto (JP); Takahiro Kamai, Kyoto (JP)

(21) Appl. No.: 13/334,119

(22) Filed: Dec. 22, 2011

Related U.S. Application Data
(63) Continuation of application No. PCT/JP2011/001541, filed on Mar. 16, 2011.

(30) Foreign Application Priority Data
Jun. 4, 2010 (JP) 2010-129466

(51) Int. Cl. G10L 13/00

(52) U.S. Cl. 704/258; 704/E13.001

(57) ABSTRACT

A device includes: an input speech separation unit which separates an input speech into vocal tract information and voicing source information; a mouth opening degree calculation unit which calculates a mouth opening degree from the vocal tract information; a target vowel database storage unit which stores pieces of vowel information on a target speaker; an agreement degree calculation unit which calculates a degree of agreement between the calculated mouth opening degree and a mouth opening degree included in the vowel information; a target vowel selection unit which selects the vowel information from among the pieces of vowel information, based on the calculated agreement degree; a vowel transformation unit which transforms the vocal tract information on the input speech, using vocal tract information included in the selected vowel information; and a synthesis unit which generates a synthetic speech using the transformed vocal tract information and the voicing source information.

### CROSS REFERENCE TO RELATED APPLICATION

This is a continuation application of PCT Patent Application No. PCT/JP2011/001541 filed on Mar. 16, 2011, designating the United States of America, which is based on and claims priority of Japanese to Patent Application No. 2010-129466 filed on Jun. 4, 2010. The entire disclosures of the above-identified applications, including the specifications, drawings and claims are incorporated herein by reference in their entirety.

### BACKGROUND OF THE INVENTION

(1) Field of the Invention

The present invention relates to voice quality conversion devices which convert voice quality of speech, and particularly to a voice quality conversion device which converts voice quality of speech by converting vocal tract information.

(2) Description of the Related Art

In recent years, the creation of synthetic speeches with significantly high sound quality has become possible with the development of speech synthesis technologies. However, the synthetic speeches have been conventionally used mainly for stereotypical purposes, such as reading out news text in an announcer tone of voice.

Services provided for mobile telephones include using a voice message spoken by a famous person, instead of a ring tone of a mobile telephone. In this way, characteristic speeches have been distributed as content. As examples of the characteristic speeches, there are: a synthetic speech with a high degree of individual reproducibility; and a synthetic speech having a characteristic prosody and voice quality recognizable based on the age of a speaker, such as a child, or based on a regionally specific accent. In order to increase enjoyment in communication between individuals, the need for creation of characteristic speeches is growing.

A human speech is generated as follows. That is, as shown in FIG. 17, when a source waveform generated from vibration of vocal cords 1601 passes through a vocal tract 1604 from a glottis 1602 to lips 1603, a voiced sound of speech is produced via influences, such as that the vocal tract 1604 is narrowed by articulatory organs like the tongue. By a speech synthesis method based on analysis and synthesis, analysis is performed on a speech according to the aforementioned principle of speech generation, so that the speech is separated into vocal tract information and voicing source information. Then, by transforming the separated vocal tract information and voicing source information, the voice quality of the synthetic speech can be obtained. Examples of the method for analyzing the speech includes a method using a model called a “vocal-tract/voicing-source model”. In the analysis using the vocal-tract/voicing-source model, a speech is separated into voicing source information and vocal tract information on the basis of a generation process of this speech. By transforming each of the separated voicing source information and vocal tract information, the converted voice quality can be obtained.

As a conventional method of converting characteristics of a speaker using a small amount of speech, the following voice quality conversion device disclosed in, for example, Japanese Unexamined Patent Application Publication No. 2002-215198 (referred to as Patent Reference 1 hereafter) is known. With this voice quality conversion device, more than one mapping function used for converting a vowel spectral envelope is prepared for each of vowels and the voice quality is converted by converting the spectral envelop using a mapping function selected based on types of preceding and following phonemes (i.e., based on a phonetic environment). FIG. 18 shows a functional configuration of the conventional voice quality conversion device disclosed in Patent Reference 1.

The conventional voice quality conversion device shown in FIG. 18 includes a spectral envelope extraction unit 11, a spectral envelope conversion unit, a speech synthesis unit 13, a speech label assignment unit 14, a label information storage unit 15, a conversion label creation unit 16, a conversion table estimation unit 17, a conversion table selection unit 18, and a conversion table storage unit 19.

The spectral envelope extraction unit 11 extracts a spectral envelope from an input speech of an original speaker. The spectral envelope conversion unit 12 converts the spectral envelope extracted by the spectral envelope extraction unit 11. The speech synthesis in unit 13 synthesizes a speech of a target speaker using the spectral envelope converted by the spectral envelope conversion unit 12.

The speech label assignment unit 14 assigns speech label information. The label information storage unit 15 stores the speech label information assigned by the speech label assignment unit 14. Based on the speech label information stored in the label information storage unit 15, the conversion label creation unit 16 creates a conversion label indicating control information used for converting the spectral envelope. The conversion table estimation unit 17 estimates a spectral-envelope conversion table used between phonemes included in the input speech of the original speaker. Based on the conversion label created by the conversion label creation unit 16, the conversion table selection unit 18 selects a spectral-envelope conversion table from the conversion table storage unit 19 described later. In the conversion table storage unit 19, a vowel conversion table 19a and a consonant conversion table 19b are stored as a spectral-envelope conversion rule for learned vowels and a spectral-envelope conversion rule for consonants, respectively.

From the vowel conversion table 19a and the consonant conversion table 19b, the conversion table selection unit 18 selects spectral-envelop conversion tables corresponding to a vowel and a consonant of a phoneme included in the input speech of the original speaker. Based on the selected spectral-envelope conversion tables, the conversion table estimation unit 17 estimates a spectral-envelope conversion table used between the phonemes included in the input speech of the original speaker. The spectral envelope conversion unit 12 converts the spectral envelope extracted by the spectral envelope extraction unit 11 from the input speech of the original speaker, based on the aforementioned selected spectral-envelope conversion tables and the estimated spectral-envelop conversion table used between the phonemes. Using the converted spectral envelope, the speech synthesis unit 13 generates a synthetic speech having the voice quality of the target speaker.

### SUMMARY OF THE INVENTION

In order to perform the voice quality conversion, the voice quality conversion device disclosed in Patent Reference 1 selects the conversion rule used for converting the spectral envelope on the basis of the phonetic environment indicating information on the preceding and following phonemes included in the speech uttered by the original speaker, and then converts the voice quality of the input speech by applying the selected conversion rule to the spectral envelop of the input speech.

However, it is difficult to determine the voice quality that should be found in the target speech, only from the phonetic environment.

The voice quality of a naturally-uttered speech is influenced by various factors, such as a speaking rate, a position in the uttered speech, and a position in an open qua phrase. For example, when a speech is naturally uttered, the beginning of a sentence is uttered distinctly and quite clearly and this clarity tends to decrease at the end of the sentence due to lazy utterance. Alternatively, when a certain word is emphatically uttered by the original speaker, the voice quality of this uttered word tends to be clearer as compared with the case where the word is not emphasized.

FIG. 19 is a graph showing vocal-tract transfer characteristics of the same type of vowels following the same preceding phoneme uttered by one speaker. In FIG. 19, the horizontal axis represents the frequency and the vertical axis represents the spectral intensity.

A curve 201 indicates the vocal-tract transfer characteristic of /a/ of /ma/ in /memai/ when “/memaigasimasxu/” is uttered. A curve 202 indicates the vocal-tract transfer characteristic of /a/ of /ma/ when “/oyugademaseN/” is uttered. It can be understood from this graph that, even when the vowels have the preceding phonemes whose positions and intensities of the format (an upward peak) indicating a resonance frequency are the same, the vocal-tract transfer characteristics of these vowels are significantly different.

As a reason for the difference, the vowel /a/ having the vocal-tract transfer characteristic indicated by the curve 201 is close to the beginning of the sentence and is a phoneme included in a content word whereas the vowel /a/ having the vocal-tract transfer characteristic indicated by the curve 202 is close to the end of the sentence and is a phoneme included in a function word. Moreover, in the auditory sense, the vowel /a/ having the vocal-tract transfer characteristic indicated by the curve 201 sounds more clearly. Here, a function word refers to a word playing a grammatical role. In the English language, examples of the function word include prepositions, conjunctions, articles, and auxiliary verbs. A content word refers to a general word which is not a function word and has a meaning. In the English language, examples of the content word include nouns, adjectives, verbs, and adverbs.

As described, when a speech is naturally uttered, a manner of utterance is different depending on a position in the sentence. To be more specific, the difference is caused by an intentional or unintentional manner of utterance, resulting into “a speech uttered distinctly and clearly” or “a speech uttered lazily and unclearly”. Hereafter, the manners of utterance between which such a difference is found are referred to as the “utterance manners”.

The utterance manner varies according to not only the phonetic environment, but also other various linguistic and physiological factors.

Without considering such variations in the utterance manner, the voice quality conversion device disclosed in Patent Reference 1 selects a mapping function based on the phonetic environment and performs the voice quality conversion. For this reason, the utterance manner of the speech obtained by the voice quality conversion is as different from the utterance manner of the speech by the original speaker. As a result, a temporal alteration pattern of the utterance manner of the speech obtained by the voice quality conversion is different from a temporal alteration pattern of the utterance manner of the speech by the original speaker. Hence, the resultant speech sounds extremely unnatural.

The temporal alteration pattern of the utterance manner is explained with reference to a conceptual diagram shown in FIG. 20. In FIG. 20, (a) shows a change in the utterance manner (i.e., the clarity) for each of the vowels included in the speech to “/memaigasimasxu/” uttered as an input speech. In X areas, phonemes are uttered clearly, meaning that the clarity is high. In Y areas, phonemes are uttered lazily, meaning that the clarity is low. Thus, the diagram shows an example where the speech is uttered with high clarity in the first half and with low clarity in the latter half.

In FIG. 20, (b) shows a conceptual diagram showing the temporal alteration pattern of the utterance manner of the speech obtained by the voice quality conversion performed according to the conversion rule selected only based on the phonetic environment. Since the conversion rule is selected by reference only to the phonetic environment, the utterance manner varies regardless of the characteristics of the input speech. For example, when the utterance manner varies as in (b) of FIG. 20, the resultant speech is uttered in a manner in which the vowel (/a/) uttered distinctly with high clarity and the vowel (/e/ or /i/) uttered lazily with low clarity alternate.

FIG. 21 is a diagram showing an example of transition of a formant 401 in the case where the voice quality conversion is performed on the speech “/oyugademaseN/” using the vowel (/a/) uttered distinctly with high clarity.

In FIG. 21, the horizontal axis represents the time and the vertical axis represents the formant frequency. First, second, and third formants are shown in order of increasing frequency. It can be seen, as for /ma/, a formant 402 obtained by the conversion into the vowel /a/ having a different utterance manner (distinctly and quite clearly) is significantly different in frequency from the formant 401 of the original speech. In this way, when the conversion is performed between the formants having significantly different frequencies, the temporal alteration transition of each formant 402 is large as shown by dashed lines in the FIG. 21. On this account, the resultant voice quality ends up being different from the voice quality of the original speech, and the sound quality is also deteriorated due to this voice quality conversion.

When the temporal alteration pattern of the resultant utterance manner is different from the temporal alteration pattern of the input speech in this way, the naturalness of variations in the utterance manner of the speech cannot be maintained after the voice quality conversion. As a consequence, the speech obtained as a result of the voice quality conversion is significantly deteriorated in the naturalness.

The present invention is conceived in view of the aforementioned conventional problem, and has an object to provide a voice quality conversion device which converts voice quality of a speech of an original speaker while maintaining temporal variations in an utterance manner of the speech without reducing naturalness, or more specifically, smoothness, in a resultant speech obtained by the voice quality conversion.

The voice quality conversion device according to an aspect of the present invention is a voice quality conversion device that converts voice quality of an input speech and includes: an input speech separation unit which separates the input speech into vocal tract information and voicing source information; a mouth opening degree calculation unit which calculates a mouth opening degree corresponding to an oral cavity volume, from the vocal tract information on a vowel included in the input speech separated by the input speech separation unit; a target vowel database storage unit in which a plurality of pieces of vowel information on a target voice quality to be used for converting the voice quality of the input speech are stored, each of the pieces of vowel information including (i) information on a type of a vowel and on a mouth opening degree of the vowel and (ii) vocal tract information; an agreement degree calculation unit which calculates a degree of agreement between the mouth opening degree calculated by the mouth opening degree calculation unit and the mouth opening degree included in the vowel information stored in the target vowel database storage unit, the vowels subjected to the calculation being of the same type between the mouth opening degrees; a target vowel selection unit which selects the vowel information from among the pieces of vowel information stored in the target vowel database storage unit, based on the agreement degree calculated by the agreement degree calculation unit; a vowel transformation unit which transforms the vocal tract information on the vowel included in the input speech, using the vocal tract information included in the vowel information selected by the target vowel selection unit; and a synthesis unit which generates a synthetic speech, using the transformed vocal tract information on the input speech obtained by the vowel transformation unit and the voicing source information separated by the input speech separation unit.

With this configuration, the vowel information indicating the mouth opening degree which agrees with the mouth opening degree indicated by the input speech is selected. This means that the vowel whose utterance manner (uttered distinctly and clearly or uttered lazily and unclearly) is the same as the input speech can be selected. Therefore, when the voice quality of the input speech is converted into the target voice quality, the voice quality conversion can be achieved while maintaining the temporal alteration pattern of the utterance manner of the input speech. As a consequence, since the resultant speech obtained by the voice quality conversion maintains the temporal alteration pattern of the utterance manner of the input speech, the voice quality conversion can be achieved without losing naturalness (i.e., smoothness) in the resultant speech.

It is preferable that each of the pieces of vowel information further includes information on a phonetic environment of the vowel, that the voice quality conversion device further includes a phonetic distance calculation unit which calculates a distance indicating similarity between a phonetic environment of the vowel included in the input speech and the phonetic environment included in the vowel information stored in the target vowel database storage unit, the vowels subjected to the calculation being of the same type between the phonetic environments, and that the target vowel selection unit selects the vowel information used for transforming the vocal tract information on the vowel included in the input speech, from among the pieces of vowel information stored in the target vowel database storage unit, based on the agreement degree calculated by the agreement degree calculation unit and the distance calculated by the phonetic distance calculation unit.

With this configuration, the vowel information on the target vowel is selected in consideration of both the distance between the phonetic environments and the degree of agreement between the mouth opening degrees. Thus, the mouth opening degree can be further considered in addition to the consideration given to the phonetic environment. As a result, as compared with the case where the vowel information is selected only based on the phonetic environment, the temporal alteration pattern of a more natural utterance manner can be reproduced and, therefore, a resultant speech with a high degree of naturalness can be obtained by the voice quality conversion.

Moreover, it is preferable that the target vowel selection unit: assigns a more weight to the distance calculated by the phonetic distance calculation unit corresponding to the agreement degree calculated by the agreement degree calculation unit, when the pieces of vowel information stored in the target vowel database storage unit are larger in number; and selects the vowel information used for transforming the vocal tract information on the vowel included in the input speech, from among the pieces of vowel information stored in the target vowel database storage unit, based on the weighted distance and the weighted agreement degree.

With this configuration, when the vowel information is to be selected, a more weight is assigned to the distance between the phonetic environments when the pieces of vowel information stored in the target vowel database storage unit are larger in number. Thus, when the pieces of vowel information stored in the target vowel database storage unit are small in number, a high priority is placed on the degree of agreement between the mouth opening degrees. With this, even when there is no vowel having a high degree of similarity in the phonetic environment, the vowel information on the vowel having the high degree of agreement in the mouth opening degree is selected. More specifically, the vowel information having the agreed utterance manner is selected. Thus, since the temporal alteration pattern of a generally natural utterance manner can be reproduced and, therefore, a speech with a high degree of naturalness can be obtained as a result of the voice quality conversion.

When the pieces of vowel information stored in the target vowel database storage unit are large in number, the vowel information on the target vowel is selected in consideration of both the similarity between the phonetic environments and the degree of agreement between the mouth opening degrees. Thus, the mouth opening degree can be further considered in addition to the consideration given to the phonetic environment. As a result, as compared with the conventional case where the vowel information is selected only based on the phonetic environment, the temporal alteration pattern of a more natural utterance manner can be reproduced and, therefore, a resultant speech with a high degree of naturalness can be obtained by the voice quality conversion.

It is preferable that the agreement degree calculation unit normalizes, for each of an original speaker of the input speech and a target speaker having the target voice quality, the mouth opening degree calculated by the mouth opening degree calculation unit and the mouth opening degree included in the vowel information stored in the target vowel database storage unit, and calculates, as the agreement degree, a degree of agreement between the normalized mouth opening degrees, the vowels subjected to the normalization being of the same type between the mouth opening degrees.

With this configuration, the degree of agreement between the mouth opening degrees is calculated using a mouth opening degree normalized for each speaker. On this account, the degree of agreement can be calculated while distinguishing the speakers whose utterance manners are different (for example, a speaker who speaks, distinctly and clearly and a speaker who mutters in an inward voice). Thus, the appropriate vowel information agreeing with the utterance manner of the original speaker can be selected. As a consequence, the temporal alteration pattern of the natural utterance manner can be reproduced for each speaker, and a resultant speech with a high degree of naturalness can be obtained by the voice quality conversion.

Moreover, the agreement degree calculation unit may normalize, for each vowel type, the mouth opening degree calculated by the mouth opening degree calculation unit and the mouth opening degree included in the vowel information stored in the target vowel database storage unit, and calculate, as the agreement degree, a degree of agreement between the normalized mouth opening degrees, the vowels subjected to the normalization being of the same type between the mouth opening degrees.

With this configuration, the degree of agreement between the mouth opening degrees is calculated using a mouth opening degree normalized for each kind of vowel. On this account, the degree of agreement can be calculated while distinguishing between the kinds of vowel, and the appropriate vowel information can be thus selected for each vowel included in the input speech. As a consequence, the temporal alteration pattern of the natural utterance manner can be reproduced, and a resultant speech with a high degree of naturalness can be obtained by the voice quality conversion.

Furthermore, the agreement degree calculation unit may calculate, as the agreement degree, a degree of agreement between a difference in the mouth opening degree in a temporal direction calculated by the mouth opening degree calculation unit and a difference in the mouth opening degree in the temporal direction included in the vowel information stored in the target vowel database storage unit, the vowels subjected to the calculation being of the same type between the mouth opening degrees.

With this configuration, the degree of agreement in the mouth opening degrees can be calculated based on the change in the mouth opening degree. This means that the vowel information can be selected in consideration of the mouth opening degree of the preceding vowel. As a result, the temporal alteration pattern of the natural utterance manner can be reproduced, and a resultant speech with a high degree of naturalness can be obtained by the voice quality conversion.

The voice quality conversion device according to another aspect of the present invention is a voice quality conversion device that converts voice quality of an input speech and includes: an input speech separation unit which separates the input speech into vocal tract information and voicing source information; a mouth opening degree calculation unit which calculates a mouth opening degree corresponding to an oral cavity volume, from the vocal tract information on a vowel included in the input speech separated by the input speech separation unit; an agreement degree calculation unit which references to a plurality of pieces of vowel information, stored in a target vowel database storage unit, on a target voice quality to be used for converting the voice quality of the input speech, each of the pieces of vowel information including (i) information on a type of a vowel and on a mouth opening degree of the vowel and (ii) vocal tract information, to calculate a degree of agreement between the mouth opening degree calculated by the mouth opening degree calculation unit and the mouth opening degree included in the vowel information stored in the target vowel database storage unit, the vowels subjected to the calculation being of the same type between the mouth opening degrees; a target vowel selection unit which selects the vowel information from among the pieces of vowel information stored in the target vowel database storage unit, based on the agreement degree calculated by the agreement degree calculation unit; a vowel transformation unit which transforms the vocal tract information on the vowel included in the input speech, using the vocal tract information included in the vowel information selected by the target vowel selection unit; and a synthesis unit which generates a synthetic speech, using the transformed vocal tract information on the input speech obtained by the vowel transformation unit and the voicing source information separated by the input speech separation unit.

With this configuration, the vowel information indicating the mouth opening degree which agrees with the mouth opening degree indicated by the input speech is selected. This means that the vowel whose utterance manner (uttered distinctly and clearly or uttered lazily and unclearly) is the same as the input speech can be selected. Therefore, when the voice quality of the input speech is converted into the target voice quality, the voice quality conversion can be achieved while maintaining the temporal alteration pattern of the utterance manner of the input speech. As a consequence, since the resultant speech obtained by the voice quality conversion maintains the temporal alteration pattern of the utterance manner of the input speech, the voice quality conversion can be achieved without losing naturalness (i.e., smoothness) in the resultant speech.

The target vowel information generation device according to another aspect of the present invention is a target vowel information generation device that generates vowel information on a target speaker having a target voice quality to be used for converting voice quality of an input speech and includes: an input speech separation unit which separates a speech of the target speaker into vocal tract information and voicing source information; a mouth opening degree calculation unit which calculates a mouth opening degree corresponding to an oral cavity volume, from the vocal tract information on the speech of the target speaker separated by the input speech separation unit; and a target vowel information generation unit which generates vowel information on the target speaker, the vowel information including (i) information on a vowel type and on the mouth opening degree calculated by the mouth opening degree calculation unit and (ii) the vocal tract information separated by the input speech separation unit.

With this configuration, the vowel information used for the voice quality conversion can be generated. This allows the target voice quality to be updated whenever necessary.

The voice quality conversion system according to another aspect of the present invention is a voice quality conversion system including the voice quality conversion device according to the aforementioned aspect of the present invention and the target vowel information generation device according to the aforementioned aspect of the present invention.

With this configuration, the vowel information indicating the mouth opening degree which agrees with the mouth opening degree indicated by the input speech is selected. This means that the vowel whose utterance manner (uttered distinctly and clearly or uttered lazily and unclearly) is the same as the input speech can be selected. Therefore, when the voice quality of the input speech is converted into the target voice quality, the voice quality conversion can be achieved while maintaining the temporal alteration pattern of the utterance manner of the input speech. As a consequence, since the resultant speech obtained by the voice quality conversion maintains the temporal alteration pattern of the utterance manner of the input speech, the voice quality conversion can be achieved without losing naturalness (i.e., smoothness) in the resultant speech.

With this configuration, the vowel information used for the voice quality conversion can be generated. This allows the target voice quality to be updated whenever necessary.

It should be noted that the present invention can be implemented not only as a voice quality conversion device including the characteristic units as described above, but also as a voice quality conversion method having, as steps, the characteristic processing units included in the voice quality conversion. Also, the present invention can be implemented as a computer program causing a computer to execute the characteristic steps included in the voice quality conversion method. It should be obvious that such a computer program can be distributed via a computer-readable nonvolatile recording medium such as a Compact Disc-Read Only Memory (CD-ROM) or via a communication network such as the Internet.

The voice quality conversion device according to the present invention is capable of maintaining a temporal alteration pattern of an utterance manner of an input speech when voice quality of the input speech is converted into a target voice quality. More specifically, since a resultant speech obtained by the voice quality conversion maintains the temporal alteration pattern of the utterance manner of the input speech, the voice quality conversion can be achieved without losing naturalness (i.e., smoothness) in the resultant speech.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing that the vocal tract cross-sectional area function is different depending on the utterance manner;

FIG. 2 is a block diagram showing a functional configuration of a voice quality conversion device according to Embodiment in the present invention;

FIG. 3 is a diagram showing an example of the vocal tract cross-sectional area function;

FIG. 4 is a diagram showing a temporal alteration pattern of a mouth opening degree of when a speech is uttered;

FIG. 5 is a flowchart showing a method of constructing a target vowel to be stored in a target vowel database (DB) storage unit;

FIG. 6 is a diagram showing an example of vowel information stored in the target vowel DB storage unit;

FIG. 7 is a diagram showing a partial auto correlation (PARCOR) coefficient of a vowel period for which conversion is performed by a vowel transformation unit;

FIG. 8 is a diagram showing vocal tract cross-sectional area functions of vowels obtained by the conversion of the vowel transformation unit;

FIG. 9 is a flowchart showing processing executed by the voice quality conversion device according to Embodiment in the present invention;

FIG. 10 is a block diagram showing a functional configuration of a voice quality conversion device according to Modification 1 of Embodiment in the present invention;

FIG. 11 is a flowchart showing processing executed by the voice quality conversion device according to Modification 1 of Embodiment in the present invention;

FIG. 12 is a block diagram showing a functional configuration of a voice quality conversion system according to Modification 2 of Embodiment in the present invention;

FIG. 13 is a block diagram showing a minimum configuration of a voice quality conversion device for implementing an aspect in the present invention;

FIG. 14 is a diagram showing a minimum configuration of vowel information stored in a target vowel DB storage unit;

FIG. 15 shows an external view of a voice quality conversion device;

FIG. 16 is a block diagram showing a hardware configuration of the voice quality conversion device;

FIG. 17 shows a cross-sectional view of a human face;

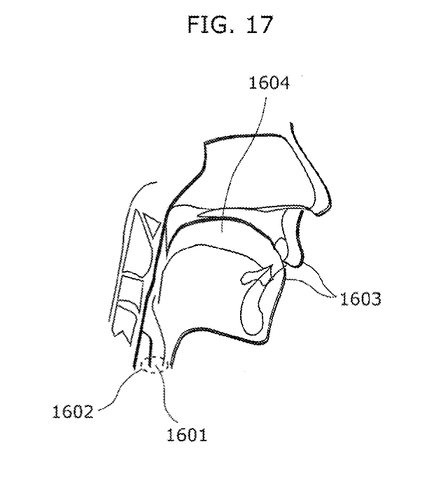

FIG. 18 is a block diagram showing a functional configuration of a conventional voice quality conversion device;

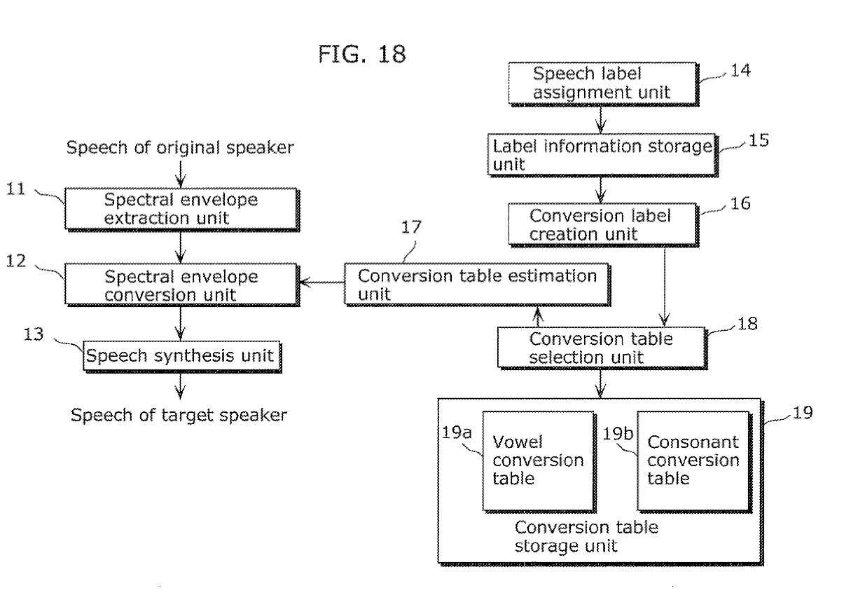

FIG. 19 is a diagram showing that the vocal tract cross-sectional area function is different depending on the utterance manner;

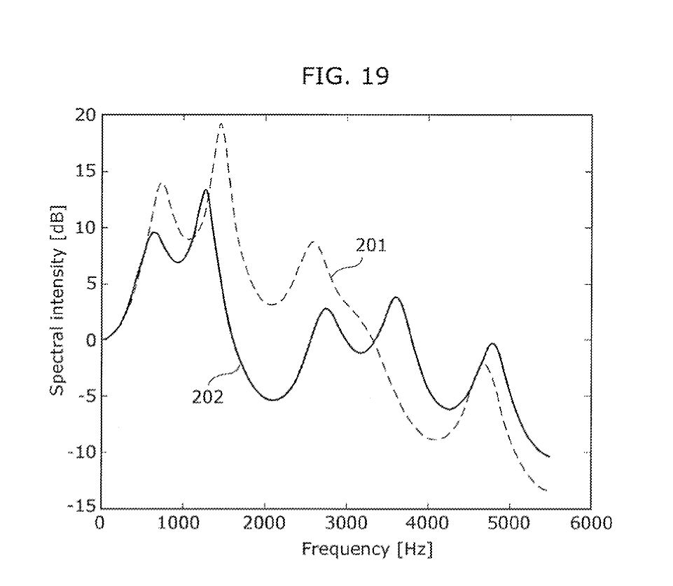

FIG. 20 is a conceptual diagram showing temporal variations in utterance manners; and

FIG. 21 is a diagram showing as an example that the formant frequency is different depending on the utterance manner.

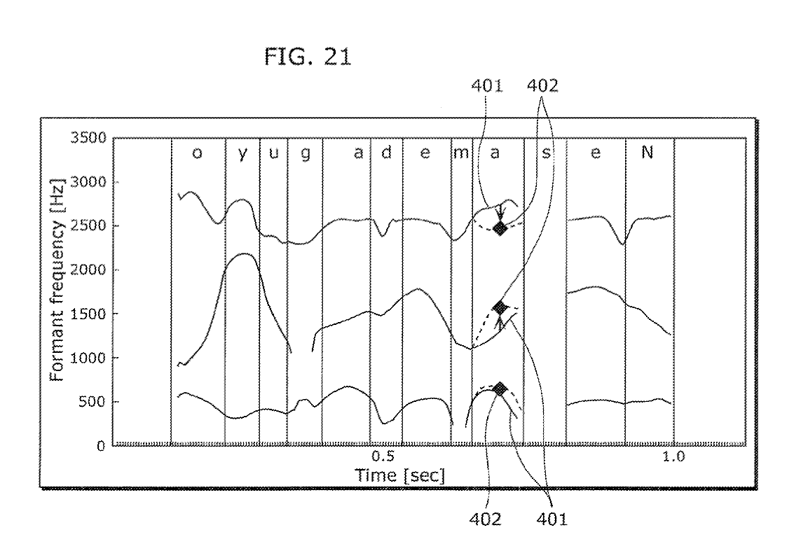

### DESCRIPTION OF THE PREFERRED EMBODIMENT

The following is a description of Embodiment according to the present invention, with reference to the drawings.

In the following, Embodiment is described based on an exemplary method of voice quality conversion whereby vowel information on a vowel having a characteristic of a speech to be used as a target (i.e., a target speech) is selected and then a predetermined computation is performed on a characteristic in a vowel period of an original speech (i.e., an input speech).

As described earlier, in the voice quality conversion, it is important to maintain the temporal variations in the utterance manner (namely, “distinctly and clearly” or “lazily and unclearly”) of the input speech.

The utterance manner is influenced by, for example, a speaking rate, a position in the uttered speech, and a position in an accented phrase. For example, when a speech is naturally uttered, the beginning of a sentence is uttered distinctly and quite clearly and this clarity tends to decrease at the end of the sentence due to lazy utterance. Alternatively, the utterance manner of when a certain word is emphasized by the original speaker is different from that of when the word is not emphasized.

However, it is difficult to implement a vowel selection method that considers all information on, for example, a position in the uttered speech, a position in an accented phrase, and the presence or absence of an emphasized word, in addition to considering the phonetic environment of the input speech as in the case of the conventional technology. This is because when all patterns are to be covered completely, this means that a large amount of information on the target speech needs to be prepared.

In the case of, for example, a system for segment concatenative speech synthesis by rule, it is not uncommon to prepare several hours to several tens of hours of speech for constructing a segment database. In fact, to implement the voice quality conversion, such a large amount of target speech can be thought to be collected as well. However, when this collection is possible, it is obvious that a voice quality conversion technique is not necessary any more and that a segment concatenative speech synthesis system may be constructed using the collected target speeches.

That is to say, the advantage of the voice quality conversion technique is that a synthetic speech with the target voice quality can be obtained using a smaller amount of target speech, as compared with the case of the segment concatenative speech synthesis system.

A voice quality conversion device in Embodiment is capable of overcoming the contradictory challenges: using a small amount of target speech; and considering the utterance manner as described above.

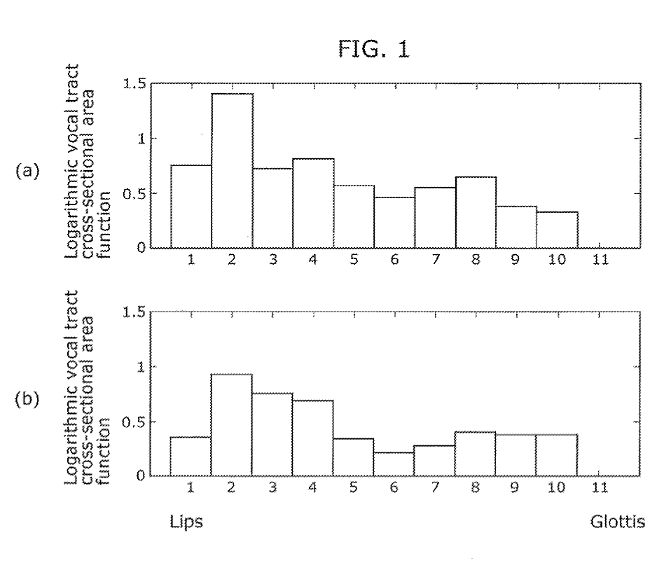

In FIG. 1, (a) shows a logarithmic vocal tract cross-sectional area function of /a/ of /ma/ included in /memai/ when “/memaigasimasxu/” is uttered as described above. In FIG. 1, (b) shows a logarithmic vocal tract cross-sectional area function of /a/ of /ma/ when “/oyugademaseN/” is uttered.

In (a) of FIG. 1, since the vowel /a/ is close to the beginning of the sentence and is a content word (i.e., an independent word), this vowel is uttered distinctly and clearly. On the other hand, in (b) of FIG. 1, since the vowel /a/ is close to the end of the sentence, this vowel is uttered lazily and the clarity is low.

The inventors of the present invention carefully observed a relation between such a difference in the utterance manners and the logarithmic vocal tract cross-sectional area function and found a link between the utterance manner and a volume of the oral cavity.

More specifically, when the volume of the oral cavity is larger, the utterance manner tends to be distinct and clear. In contrast to this, when the volume of the oral cavity is smaller, the utterance manner tends to be lazy and the clarity tends to be low.

Here, the oral cavity volume that can be calculated from the speech is used as an index of a degree of how much the mouth is opened (referred to as the “mouth opening degree” hereafter). With this, a vowel having a desired utterance manner can be found from target speech data. When the utterance manner is indicated by one value representing the oral cavity volume, consideration does not need to be given to the information on various combination of a position in an uttered speech, a position in an accented phrase, and the presence or absence of an emphasized word. This allows the vowel having the desired characteristic to be found from the small amount of target speech data. Moreover, the necessary amount of target speech data can be reduced by reducing the number of types of phonetic environments. This reduction in number can be achieved by forming one category of phonemes having similar characteristics. With this, the phonetic environment does not need to be verified for each phoneme.

To put it simply, according to the present invention, the temporal alteration pattern of the utterance manner is maintained by using the oral cavity volume so as to implement the voice quality conversion without losing naturalness in a resultant speech.

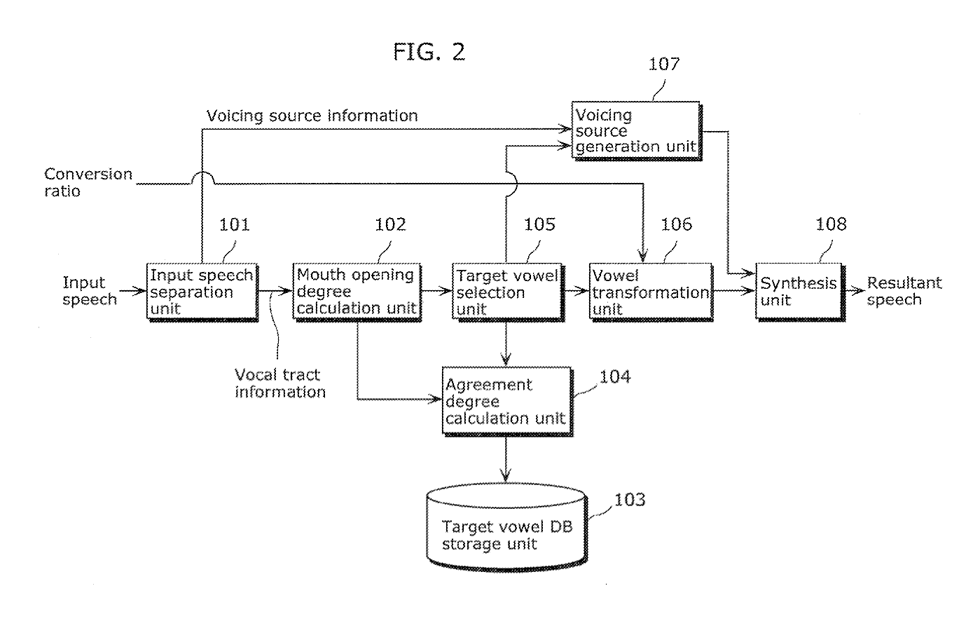

FIG. 2 is a block diagram showing a functional configuration of the voice quality conversion device according to Embodiment in the present invention.

The voice quality conversion device includes an input speech separation unit 101, a mouth opening degree calculation unit 102, a target vowel DB storage unit 103, an agreement degree calculation unit 104, a target vowel selection unit 105, a vowel transformation unit 106, a voicing source generation unit 107, and a synthesis unit 108.

The input speech separation unit 101 separates an input speech into vocal tract information and voicing source information.

The mouth opening degree calculation unit 102 calculates a mouth opening degree from a cross-sectional area of the vocal tract at each time of the input speech, using the vocal tract information on a vowel that is separated by the input speech separation unit 101. To be more specific, the mouth opening degree calculation unit 102 calculates the mouth opening degree corresponding to the oral cavity volume, from the vocal tract information on the input speech separated by the input speech separation unit 101.

The target vowel DB storage unit 103 is a storage unit in which a plurality of pieces of vowel information on a target voice quality are stored. More specifically, the target vowel DB storage unit 103 stores the pieces of vowel information on a target voice quality to be used for converting the voice quality of the input speech. Here, each piece of the vowel information includes: information on a type of a vowel and on a mouth opening degree of the vowel; and vocal tract information. The vowel information is described in detail later.

The agreement degree calculation unit 104 calculates a degree of agreement between the mouth opening degree calculated by the as mouth opening degree calculation unit 102 and the mouth opening degree included in the vowel information stored in the target vowel DB storage unit 103. This degree of agreement between these mouth opening degrees is simply referred to as the “agreement degree” hereafter. Note also here that the vowels subjected to the calculation between the mouth opening degrees are of the same type.

Based on the agreement degree calculated by the agreement degree calculation unit 104, the target vowel selection unit 105 selects the vowel information used for converting the vocal tract information on the vowel included in the input speech, from among the pieces of vowel information stored in the target vowel DB storage unit 103.

The vowel transformation unit 106 converts the voice quality by transforming the vocal tract information on the vowel included in the input speech, using the vocal tract information included in the vowel information selected by the target vowel selection unit 105.

The voicing source generation unit 107 generates a voicing source waveform using the voicing source information separated by the input speech separation unit 101.

The synthesis unit 108 generates a synthetic speech using: the vocal tract information in which the voice quality has been converted by the vowel transformation unit 106; and the voicing source waveform generated by the voicing source generation unit 107.

The voice quality conversion device configured as described can convert the original voice quality of the input speech into the target voice quality stored in the target vowel DB storage unit 103 while maintaining the temporal variations in the utterance manner of the input speech.

The following is a detailed description for each of the components.

### [Input Speech Separation Unit 101]

The input speech separation unit 101 separates the input speech into the vocal tract information and the voicing source information, using a vocal-tract/voicing-source model which is a speech generation model simulating a speech utterance mechanism. Here, the vocal-tract/voicing-source model used for this separation is not limited to this, and any type of model may be used.

For example; when a linear predictive coding (LPC) model is used as the vocal-tract/voicing-source model, a sample value s (n) having a speech waveform is predicted from p number of preceding sample values. Here, the sample value s (n) can be expressed by Equation 1 as follows.

s(n)≅α₁s(n−1)+α₂s(n−2)+α₃s(n−3)+Λ+αₚs(n−p) [Equation 1]

A coefficient αᵢ (Where i=n−1 to n−p) corresponding to the p number of sample values can be calculated by a method such as a correlation method or a covariance method. Using the calculated coefficient, an input speech signal is generated by Equation 2 as follows.

$$S ( z ) = \frac{1}{A ( z )} U ( z ) \qquad [ Equation 2 ]$$

Here, S (z) represents a value obtained by performing z-transformation on a speech signal s (n). Moreover, U (z) represents a value obtained by performing z-transformation on a voicing source signal u (n) and denotes a signal obtained by performing inverse filtering on the input speech S (z) using vocal tract information 1/A (z).

The input speech separation unit 101 may further calculate a PARCOR coefficient using a linear predictive coefficient analyzed by LPC analysis. The PARCOR coefficient is known to have a more desirable interpolation property than the linear predictive coefficient.

The PARCOR coefficient can be calculated using the Levinson-Durbin-Itakura algorithm. Note that the PARCOR coefficient has the following two features.

Feature 1: Variations in a lower order coefficient have a larger influence on a spectrum, and variations in a higher order coefficient have a smaller influence.

Feature 2: The variations in a higher order coefficient have influence evenly over an entire region.

In the following description, the PARCOR coefficient is used as the vocal tract information. It should be noted that the vocal tract information to be used here is not limited to the PARCOR coefficient, and the linear predictive coefficient may be used. Or, a line spectrum pair (LSP) may be used.

Moreover, when an autoregressive with exogenous input (ARX) model is used as the vocal-tract/voicing source model, the input speech separation unit 101 separates the input speech into the vocal tract information and the voicing source information via ARX analysis. The ARX analysis is significantly different from the LPC analysis in that a mathematical voicing source model is used as the voicing source. Moreover, unlike the LPC analysis, the ARX analysis can separate the speech into the vocal tract information and the voicing source information more accurately even when an analysis-target period includes a plurality of fundamental periods, as disclosed in “Robust ARX-based speech analysis method taking voicing source pulse train into account” by Ohtsuka and Kasuya, in The Journal of the Acoustical Society of Japan, 58 (7), 2002, pp. 386-397.

In the ARX analysis, a speech is generated by a generation process represented by Equation 3 below. In Equation 3, S (z) represents a value obtained by performing z-transformation on a speech signal s (n). Moreover, U (z) represents a value obtained by performing z-transformation on a voicing source signal u (n), and E (z) represents a value obtained by performing z-transformation on a voiceless noise source e (n). To be more specific, when the ARX analysis is executed, the voiced sound is generated by the first term on the right side of Equation 3 and the voiceless sound is generated by the second term on the right side of Equation 3.

$$S ( z ) = \frac{1}{A ( z )} U ( z ) + \frac{1}{A ( z )} E ( z ) \qquad [ Equation 3 ]$$

Here, as a model for the voicing source signal u (t)=u (nTs), a sound model represented by Equation 4 is used. Note that Ts represents a sampling period.

$$u ( t ) = \{ \begin{matrix}2 a ( t - OQ \times T 0 ) - 3 {b ( t - OQ \times T 0 )}^{2} , & - OQ \times T 0 < t \leq 0 \\ 0 , & elsewhere\end{matrix} \\ a = \frac{27 AV}{4 {OQ}^{2} T 0} , b = \frac{27 AV}{4 {OQ}^{3} T {0}^{2}} . \qquad [ Equation 4 ]$$

In Equation 4, AV represents voicing source amplitude, TO represents a fundamental period, and OQ represents an open quotient of the glottis. In the case of the voiced sound, the first term of Equation 4 is used. In the case of the voiceless sound, the second term of Equation 4 is used. The glottal OQ indicates an opening ratio of the glottis in one fundamental period. It is known that the speech tends to sound softer when the glottal OQ is larger.

The ARX analysis has the following advantages as compared with the LPC analysis.

Advantage 1: Since a voicing-source pulse train is arranged corresponding to the fundamental periods in an analysis window to perform the analysis, the vocal tract information can be extracted with stability even from a high pitched voice of, for example, a female or child.

Advantage 2: High performance can be expected in the separation of the input speech into the vocal tract information and the voicing sound information, especially in the case of a close vowel, such as /i/ or /u/, where a fundamental frequency F0 and a first formant frequency F1 are close to each other.

In the voicing sound period, U (z) can be obtained by performing the inverse filtering on the input speech S (z) using the vocal tract information 1/A (z), as in the LPC analysis.

The vocal tract information 1/A (z) used in the ARX analysis has the same formats as the system function used in the LPC analysis. On this account, the input speech separation unit 101 may convert the vocal tract information into a PARCOR coefficient according the same method used by the LPC analysis.

### [Mouth Opening Degree Calculation Unit 102]

The mouth opening degree calculation unit 102 calculates a mouth opening degree corresponding to the oral cavity volume, for each vowel in a vowel sequence included the input speech, using the vocal tract information separated by the input speech separation unit 101. For example, when the input speech is “/oyugademeseN/”, the mouth opening degree is calculated for each of the vowels included in a vowel sequence Vn={/o/, /u/, /a/, /e/, /a/, /e/}.

More specifically, the mouth opening degree calculation unit 102 calculates a vocal tract cross-sectional area function from the PARCOR coefficient extracted as the vocal tract information, using Equation 5.

$$\frac{{A}_{i}}{{A}_{i + 1}} = \frac{1 - {k}_{i}}{1 + {k}_{i}} ( i = i , Λ , N ) \qquad [ Equation 5 ]$$

Here, kᵢ represents an i-th order PARCOR coefficient and Aᵢ represents an i-th vocal tract cross-sectional area, where A_{N+1}=1.

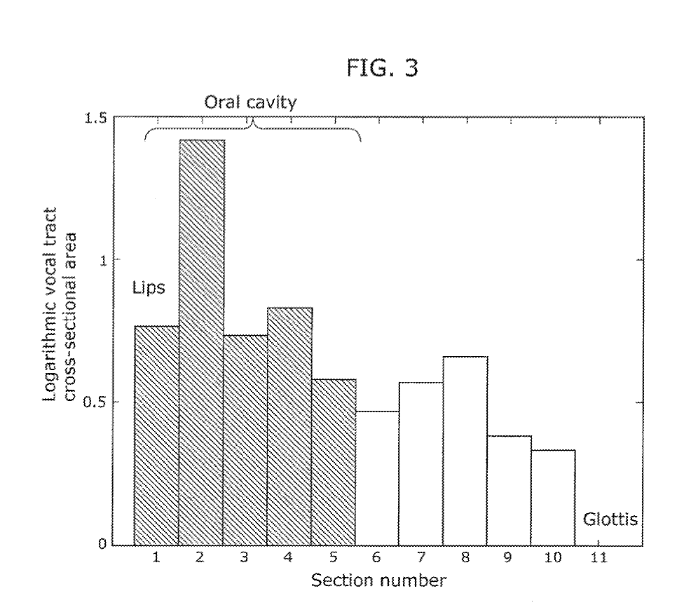

FIG. 3 is a diagram showing a logarithmic vocal tract cross-sectional area function of a vowel /a/ included in a speech. The vocal tract area is divided into eleven sections from the glottis to the lips (where N=10). The horizontal axis represents the section number and the vertical axis represents the logarithmic vocal tract cross-sectional area. Note that Section 11 denotes the glottis and Section 1 denotes the lips.

A shaded area in this diagram can be generally thought to be the oral cavity. When an area from Section 1 to Section T is the oral cavity (T=5 in FIG. 3), the mouth opening degree C. can be defined by Equation 6 as follows. Here, it is preferable for T to be changed according to the order of the LPC analysis or the ARX analysis. For example, in the case of a 10th-order LPC analysis, it is preferable for T to be 3 to 5. However, note that a specific order is not limited.

$$C = {\sum }_{i = 1}^{T} {A}_{i} \qquad [ Equation 6 ]$$

The mouth opening degree calculation unit 102 calculates a mouth opening degree C. defined by Equation 6 for each of the vowels included in the input speech. Alternatively, the mouth opening degree may be calculated as a sum of logarithmic cross-sectional areas, as expressed by Equation 7.

$$C = {\sum }_{i = 1}^{T} log {A}_{i} \qquad [ Equation 7 ]$$

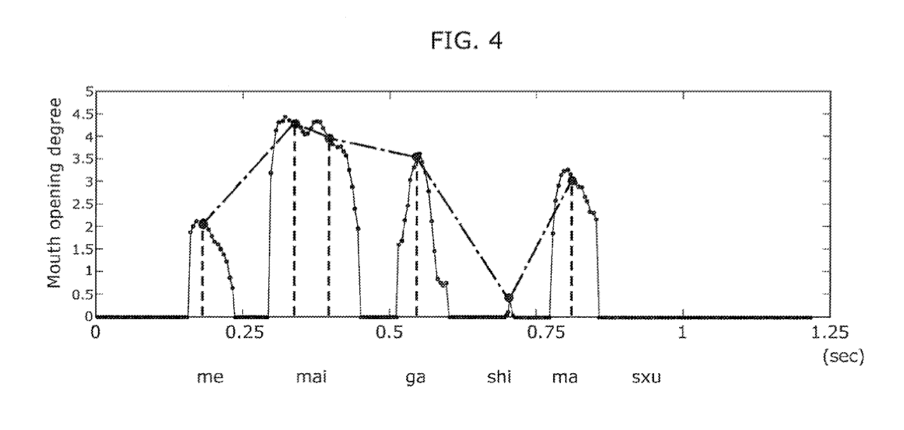

FIG. 4 is a diagram showing temporal variations in the mouth opening degree calculated according to Equation 6, for the speech “/memaigasimasxu/”.

As shown, the mouth opening degree temporally varies. A disturbance in this temporal alteration pattern deteriorates the naturalness.

In this way, based on the mouth opening degree (or, the oral cavity volume) calculated using the vocal tract cross-sectional area function, consideration can be given not only to how much the lips are open but also to the shape of the oral cavity (a position of the tongue, for example) which cannot be observed directly from the outside.

### [Target Vowel DB Storage Unit 103]

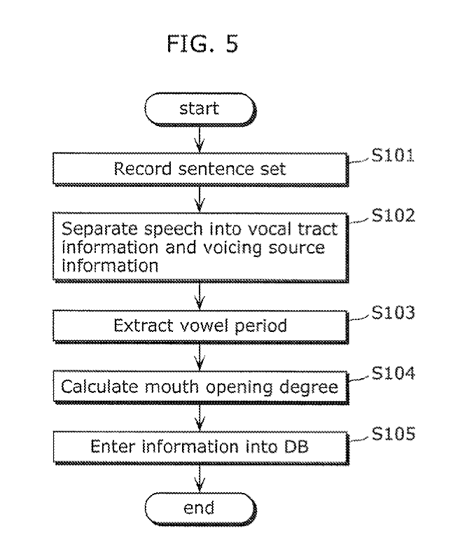

The target vowel DB storage unit 103 is a storage unit in which the vowel information on a target voice quality used in voice quality conversion is stored. Note that the vowel information is previously prepared and stored in the target vowel DB storage unit 103. An example of constructing the vowel information stored in the target vowel DB storage unit 103 is explained with reference to the flowchart shown in FIG. 5.

In Step S101, a speaker having a target voice quality is asked to utter sentences, and these sentences are recorded as a sentence set. Although the number of sentences is not limited, a speech having several sentences to several tens of sentences is recorded. The speech is recorded so that at least two utterances are obtained for each type of vowel.

In Step S102, the speech of the recorded sentence set is separated into the vocal tract information and the voicing source information. To be more specific, the input speech separation unit 101 separates the vocal tract information from the speech of the sentence set.

In Step S103, a period corresponding to a vowel is extracted from the vocal tract information separated in Step S102. The extraction method is not particularly limited. The vowel period may be extracted by a person, or may be automatically extracted by an automatic labeling method.

In Step S104, the mouth opening degree is calculated for each vowel period extracted in Step S103. To be more specific, the mouth opening degree calculation unit 102 calculates the mouth opening degree. Here, the mouth opening degree calculation unit 102 performs the calculation to obtain the mouth opening degree in the central area of the extracted vowel period. It should be obvious that it is not limited to the central area, and that all the characteristics in the vowel period may be calculated or that an average value of the mouth opening degrees of the vowel period may be calculated. Alternatively, a median value of the mouth opening degrees in the vowel period may be calculated.

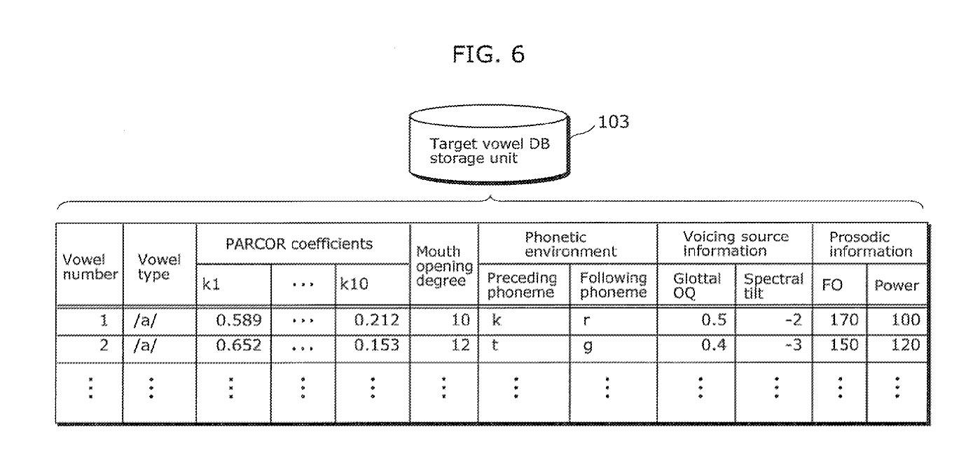

In Step S105, for each of the vowels, the mouth opening degree of the vowel calculated in Step S104 and information used for voice quality conversion are entered as the vowel information into the target vowel DB storage unit 103. More specifically, as shown in FIG. 6, the vowel information includes: a vowel number for identifying the vowel information; a type of vowel; PARCOR coefficients representing the vocal tract information in the vowel period; a mouth opening degree; a phonetic environment of the vowel (such as information on preceding and following phonemes, information on preceding and following syllables, or articulation points of the preceding and following phonemes); the voicing source information in the vowel period (such as a spectral tilt and a glottal open quotient OQ); and prosodic information (such as a fundamental frequency and power).

### [Agreement Degree Calculation Unit 104]

The agreement degree calculation unit 104 compares the mouth opening degree (C.) of the vowel included in the input speech calculated by the mouth opening degree calculation unit 102 and the vowel information, stored in the target vowel DB storage unit 103, on the vowel which is the same type as the current vowel included in the input speech, to calculate the degree of agreement between the mouth opening degrees.

In Embodiment, an agreement degree Sᵢⱼ between the mouth opening degrees can be calculated one of the following calculation methods. It should be noted that the agreement degree Sᵢⱼ is a smaller value when the two mouth opening degrees agree more with each other, and is a larger value when the two degrees agree less with each other. Here, the agreement degree can be set to be larger when the two mouth opening degrees agree more with each other.

### (First Calculation Method)

As expressed by Equation 8, the agreement degree calculation unit 104 obtains the agreement degree Sᵢ; by calculating a difference between a mouth opening degree Cᵢ calculated by the mouth opening degree calculation unit 102 and a mouth opening degree Cᵢ included in the vowel information, stored in the target vowel DB storage unit 103, on the vowel which is the same type as the current vowel included in the input speech.

Sᵢⱼ=|Cᵢ−Cⱼ| [Equation 8]

### (Second Calculation Method)

As expressed by Equation 9, the agreement degree calculation unit 104 obtains the agreement degree Sᵤ by calculating a difference between a speaker-based normalized mouth opening degree (simply referred to as the “speaker normalized degree” hereafter) Cᵢ^{S} and a speaker normalized degree Cᵢ^{S}. Here, the speaker normalized degree Cᵢ^{S} is obtained for each speaker by normalizing the mouth opening degree Cᵢ calculated by the mouth opening degree calculation unit 102 using the average value and standard deviation of the mouth opening degree of the input speech. Moreover, the speaker normalized degree Cᵢ^{S} is obtained by normalizing the mouth opening degree Cⱼ included in the vowel information, stored in the target vowel DB storage unit 103, on the vowel which is the same type as the current vowel included in the input speech, using the average value and standard deviation of the mouth opening degree of the target speaker.

With the second calculation method, the degree of agreement between the mouth opening degrees is calculated using a mouth opening degree normalized for each speaker. On this account, the degree of agreement can be calculated while distinguishing the speakers whose utterance manners are different (for example, a speaker who speaks distinctly and clearly and a speaker who mutters in an inward voice). Thus, the appropriate vowel information agreeing with the utterance manner of the original speaker can be selected. As a consequence, the temporal alteration pattern of the natural utterance manner can be reproduced for each speaker, and a resultant speech with a high degree of naturalness can be obtained by the voice quality conversion.

Sᵢⱼ=|Cᵢ^{S}−Cⱼ^{S}| [Equation 9]

The speaker normalized degree Cᵢ^{S} can be calculated by Equation 10, for example.

$${C}_{i}^{S} = \frac{{C}_{i} - {μ}^{S}}{{σ}^{S}} \qquad [ Equation 10 ]$$

Note that μ^{S} represents an average of the mouth opening degrees of the original speaker, and σ^{S} represents a standard deviation of the mouth opening degrees of the original speaker.

### (Third Calculation Method)

As expressed by Equation 11, the agreement degree calculation unit 104 obtains the agreement degree Sᵢⱼ by calculating a difference between a phoneme-based normalized mouth opening degree (simply referred to as the “phoneme normalized degree” hereafter) Cᵢ^{P} and a phoneme normalized degree Cⱼ^{P}. Here, the phoneme normalized degree Cᵢ^{P} is obtained by normalizing the mouth opening degree Cᵢ calculated by the mouth opening degree calculation unit 102 using the average value and standard deviation of the current vowel included in the input speech. Moreover, the phoneme normalized degree Cⱼ^{P} is obtained by normalizing the mouth opening degree Cⱼ included in the vowel information, stored in the target vowel DB storage unit 103, on the vowel which is the same type as the current vowel included in the input speech, using the average value and standard deviation of the mouth opening degree of when the target speaker utters the current vowel.

Sᵢⱼ=|Cᵢ^{P}−Cⱼ^{P}| [Equation 11]

The phoneme normalized degree Cᵢ^{P} can be calculated by Equation 12, for example.

$${C}_{i}^{P} = \frac{{C}_{i} - {μ}^{P}}{{σ}^{P}} . \qquad [ Equation 12 ]$$

Note that μ^{P} represents an average of the mouth opening degrees of when the original speaker utters the current vowel, and σ^{P} represents a standard deviation of the mouth opening degrees of when the original speaker utters the current vowel.

With the third calculation method, the degree of agreement between the mouth opening degrees is calculated using a mouth opening degree normalized for each kind of vowel. On this account, the degree of agreement can be calculated while distinguishing between the kinds of vowel, and the appropriate vowel information can be thus selected for each vowel included in the input speech. As a consequence, the temporal alteration pattern of the natural utterance manner can be reproduced, and a resultant speech with a high degree of naturalness can be obtained by the voice quality conversion.

### (Fourth Calculation Method)

As expressed by Equation 13, the agreement degree calculation unit 104 obtains the agreement degree Sᵢⱼ by calculating a difference between a mouth opening degree difference (simply referred to as the “degree difference” hereafter) Cᵢ^{D} and a degree difference Cⱼ^{D}. Here, the degree difference Cᵢ^{D} represents a mouth opening degree indicating a difference between the mouth opening degree Cᵢ calculated by the mouth opening degree calculation unit 102 and a mouth opening degree of a vowel preceding the vowel corresponding to the mouth opening degree Cᵢ of the input speech. Moreover, the degree difference Cⱼ^{D} represents a mouth opening degree indicating a difference between: the mouth opening degree Cⱼ included in the vowel information, stored in the target vowel DB storage unit 103, on the vowel which is the same type as the vowel included in the input speech; and a mouth opening degree of a vowel preceding the vowel corresponding to the mouth opening degree Cⱼ. It should be noted that, when the agreement degree is calculated according to the fourth calculation method, the degree difference Cⱼ^{D} or the mouth opening degree of the preceding vowel is included in the corresponding vowel information stored in the target vowel DB storage unit 103 shown in FIG. 6.

Sᵢⱼ=|Cᵢ^{D}−Cⱼ^{D}| [Equation 13]

The degree difference Cᵢ^{D} can be calculated by Equation 14, for example.

Cᵢ^{D}=Cᵢ−Cᵢ₋₁ [Equation 14]

Note that Cᵢ₋₁ represents the last mouth opening degree of a vowel before the mouth opening degree Cᵢ.

With the fourth calculation method, the degree of agreement in the mouth opening degrees can be calculated based on the change in the mouth opening degree. This means that the vowel information can be selected in consideration of the mouth opening degree of the preceding vowel. As a result, the temporal alteration pattern of the natural utterance manner can be reproduced, and a resultant speech with a high degree of naturalness can be obtained by the voice quality conversion.

### [Target Vowel Selection Unit 105]

The target vowel selection unit 105 selects the vowel information from the target vowel DB storage unit 103, for each vowel included in the input speech, based on the agreement degree calculated by the agreement degree calculation unit 104.

To be more specific, the target vowel selection unit 105 selects, from the target vowel DB storage unit 103, the vowel information where the agreement degree calculated by the agreement degree calculation unit 104 is a minimum, corresponding to the vowel sequence included the input speech. That is, for each vowel included in the vowel sequence of the input speech, the target vowel selection unit 105 selects, from among the pieces of vowel information stored in the target vowel DB storage unit 103, the vowel information including the mouth opening degree that agrees most with the mouth opening degree of input speech.

### [Vowel Transformation Unit 106]

The vowel transformation unit 106 transforms (or, converts) the vocal tract information for each of the vowels of the vowel sequence included in the input speech, into the vocal tract information included in the vowel information selected by the target vowel selection unit 105.

The conversion method is described in detail as follows.

The vowel transformation unit 106 approximates, using a polynomial expressed by Equation 15, a corresponding-order sequence of the vocal tract information expressed by the PARCOR coefficient of the vowel period, for each of the vowels in the vowel sequence included in the input speech. For example, the 10th-order PARCOR coefficient is approximated by the polynomial expressed by Equation 15 for each of the orders. As a result, 10 types of polynomials can be obtained. The order of the polynomial is not particularly limited, and an appropriate order can be set.

$${\hat{y}}_{a} = {\sum }_{i = 0}^{p} {a}_{i} {x}^{i} \qquad [ Equation 15 ]$$

Here,

ŷₐ

represents the PARCOR coefficient approximated by the polynomial, aᵢ represents the coefficient of the polynomial, and x represents the time.

Here, one phoneme period can be used as an example of a unit for polynomial approximation. Alternatively, instead of the phoneme period, a time period from the center of the current phoneme to the center of a next phoneme may be used as a unit for approximation. The following describes the case where the phoneme period is used as the unit for approximation.

As an example of the polynomial, a quintic polynomial can be considered. However, the order of the polynomial is not limited to five. Note that, instead of using the polynomial, the approximation may be performed using a regression line for each phoneme period unit.

Similarly, the vowel transformation unit 106 approximates, using a polynomial expressed by Equation 16, the vocal tract information expressed by the PARCOR coefficient in the vowel information selected by the target vowel selection unit 105. As a result, the vowel transformation unit 106 obtains a coefficient bᵢ of the polynomial.

$${\hat{y}}_{b} = {\sum }_{i = 0}^{p} {b}_{i} {x}^{i} \qquad [ Equation 16 ]$$

Here,

ŷ_{b}

represents the PARCOR coefficient approximated by the polynomial, bᵢ represents the coefficient of the polynomial, and x represents the time.

Next, according to Equation 17, the vowel transformation unit 106 calculates a coefficient cᵢ in the polynomial of the transformed PARCOR coefficient using: the coefficient aᵢ in the polynomial of the PARCOR coefficient of the vowel included in the input speech; the coefficient bᵢ in the polynomial of the PARCOR coefficient of the vowel information selected by the target vowel selection unit 105; and a conversion ratio r.

cᵢ=aᵢ+(bᵢ−aᵢ)×r [Equation 17]

In general, the conversion ratio is specified in a range expressed by −1≦r≦1.

However, even when the conversion ratio r exceeds this range, the coefficient can be converted using Equation 17. When the ratio r exceeds 1, the conversion results in more emphasizing a difference between the original vocal tract information (aᵢ) and the target vocal tract information (bᵢ). When the ratio r is a negative value, the conversion results in more emphasizing the difference between the original vocal tract information (aᵢ) and the target vocal tract information (bᵢ) in an opposite direction.

The vowel transformation unit 106 obtains the transformed vocal tract information according to Equation 18, using the coefficient cᵢ in the polynomial calculated by the conversion.

$${\hat{y}}_{c} = {\sum }_{i = 0}^{p} {c}_{i} {x}^{i} \qquad [ Equation 18 ]$$

By performing the conversion for each order of the PARCOR coefficient, the PARCOR coefficient can be converted, at the specified conversion ratio, into the PARCOR coefficient in the vowel information selected by the target vowel selection unit 105.

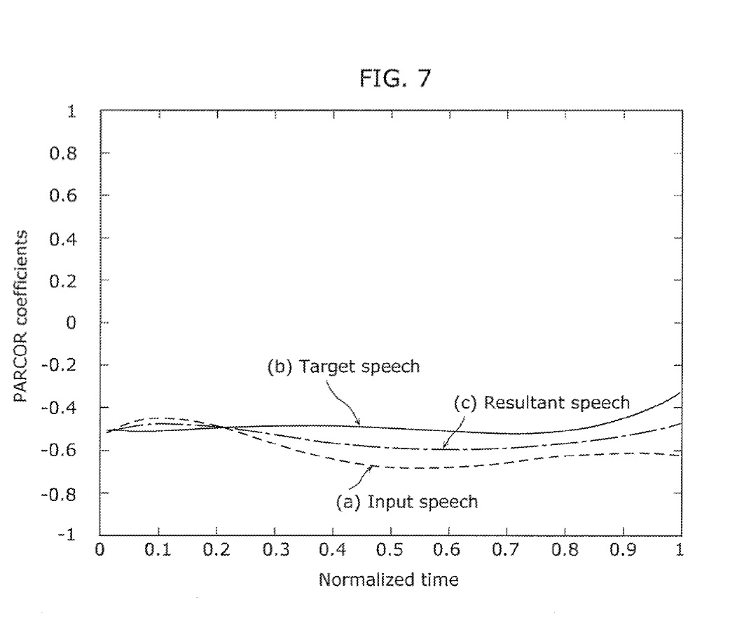

FIG. 7 shows an example where the above-described conversion is actually performed on the vowel /a/. In FIG. 7, the horizontal axis represents the normalized time and the vertical axis represents the first-order PARCOR coefficient. The normalized time refers to a time that is normalized based on a length of the vowel period and takes on values from 0 to 1. This normalization is performed for the purpose of aligning the time axes when the vowel period of the original speech is different from the period indicated by the vowel information selected by the target vowel selection unit 105. Hereafter, the vowel information selected by the target vowel selection unit 105 may be referred to as the target vowel information. In FIG. 7, (a) indicates transition of a coefficient of when a male speaker utters /a/. Similarly, (b) in FIG. 7 indicates transition of a coefficient of when a female speaker utters /a/. Moreover, (c) in FIG. 7 indicates transition of a coefficient of when the coefficient of the male speaker is converted into the coefficient of the female speaker at the conversion ratio of 0.5 using the above-described conversion method. As can be seen from FIG. 7, the above-described conversion allows the PARCOR coefficient to be interpolated between the speakers.

In order to prevent the value of the PARCOR coefficient from being discontinuous at the border between phonemes, the vowel transformation unit 106 sets an appropriate transient period at the border to perform the interpolation processing. Although the interpolation method is not particularly limited, the discontinuity of the PARCOR coefficient may be resolved by, for example, a linear interpolation method.

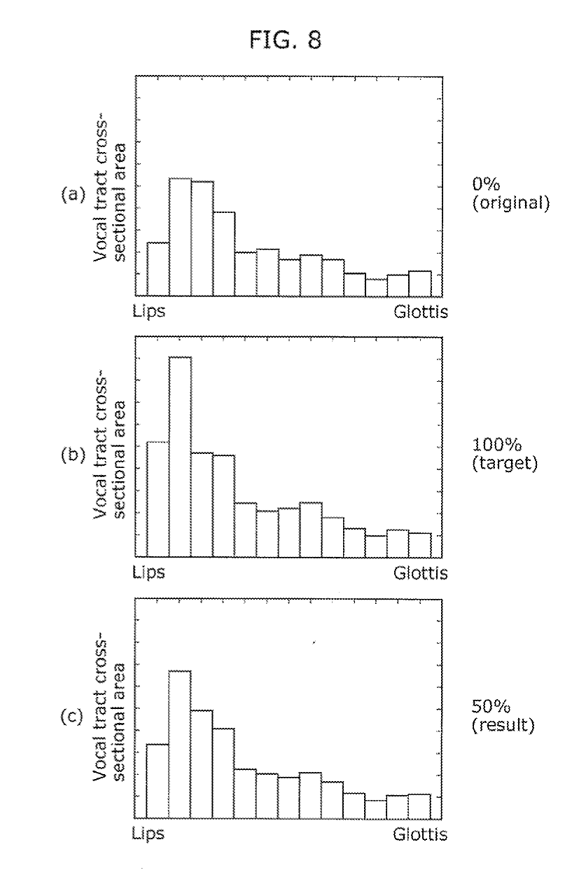

FIG. 8 is a diagram showing vocal tract cross-sectional areas at the temporal centers of the converted vowel periods. In FIG. 8, each graph shows the vocal tract cross-sectional area obtained as a result of converting the PARCOR coefficient at the temporal center shown in FIG. 7 into the vocal tract cross-sectional area according to Equation 5.

In FIG. 8, (a) shows a graph of the vocal tract cross-sectional area of the male speaker, i.e., the original speaker. Moreover, (b) shows a graph of the vocal tract cross-sectional area of the female speaker, i.e., the target speaker. Then, (c) shows a graph of the vocal tract cross-sectional area obtained by the conversion performed at the conversion ratio of 0.5. As can be also seen from FIG. 8, the vocal tract shown in (c) is intermediate in shape between the vocal tracts of the original and target speakers.

### [Voicing Source Generation Unit 107]

The voicing source generation unit 107 generates the voicing source information on the synthetic speech obtained as a result of the voice quality conversion, using the voicing source information separated by the input speech separation unit 101.

To be more specific, the voicing source generation unit 107 generates the voicing source information on the target speech by changing the fundamental frequency or power of the input speech. The method of changing the fundamental frequency or power is not particularly limited. For example, the voicing source generation unit 107 changes the fundamental frequency or power of the voicing source information on the input speech so that the average fundamental frequency and the average power included in the target vowel information agree with each other. More specifically, when the average fundamental frequency is to be converted, the pitch synchronous overlap add (PSOLA) method can be employed which is disclosed in “Diphone Synthesis using an Overlap-Add technique for Speech Waveforms Concatenation”, Proceedings of the IEEE International Conference on Acoustics, Speech and Signal Processing, 1997, pp. 2015 to 2018. With this method, the fundamental frequency in the voicing source information can be changed. Furthermore, by adjusting power for each pitch waveform when changing the fundamental frequency according to the PSOLA method, the power of the input speech can be converted.

### [Synthesis Unit 108]

The synthesis unit 108 generates the synthetic speech, using the vocal tract information converted by the vowel transformation unit 106 and the voicing source information generated by the voicing source generation unit 107. Although the synthesis method is not particularly limited, the PARCOR synthesis may be employed when the PARCOR coefficient is used as the vocal tract information. Alternatively, the synthetic speech may be generated after the PARCOR coefficient is converted into the LPC coefficient. Or, a formant may be extracted so that the speech synthesis can be as achieved by formant synthesis. Additionally, an LSP coefficient may be calculated from the PARCOR coefficient so that the speech synthesis can be achieved by LSP synthesis.

### (Flowchart)

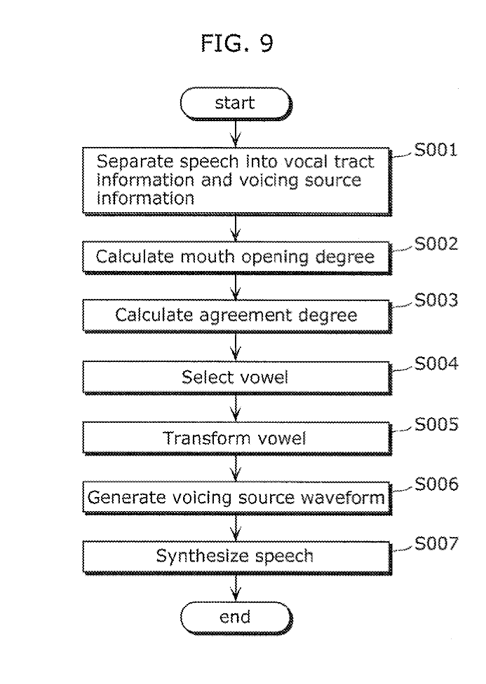

A specific operation performed by the voice quality conversion device in Embodiment is described, with reference to a flowchart shown in FIG. 9.

The input speech separation unit 101 separates an input speech into vocal tract information and voicing source information (S001). The mouth opening degree calculation unit 102 calculates mouth opening degrees for the vowel sequence included in the input speech, using the vocal tract information separated in Step S001 (S002).

The agreement degree calculation unit 104 calculates a degree of agreement between: the mouth opening degree of a vowel in the vowel sequence of the input speech that is calculated in Step S002; and the mouth opening degree of a target vowel candidate (i.e., the vowel information on the vowel which is the same type as the vowel included in the input speech) stored in the target vowel DB storage unit 103 (Step S003).

The target vowel selection unit 105 selects the target vowel information for each of the vowels in the vowel sequence included in the input speech, based on the agreement degree calculated in Step S003 (Step S004). More specifically, for each vowel of the vowel sequence included the input speech, the target vowel selection unit 105 selects, from among the pieces of vowel information stored in the target vowel DB storage unit 103, the vowel information including the mouth opening degree that agrees most with the mouth opening degree of the input speech.

The vowel transformation unit 106 transforms the vocal tract information using the target vowel information selected in Step S004, for each vowel of the vowel sequence included in the input speech (Step S005).

The voicing source generation unit 107 generates a voicing source waveform using the voicing source information separated from the input speech in Step S001 (Step S006).

The synthesis unit 108 synthesizes a speech using the vocal tract information transformed in Step S005 and the voicing source waveform generated in Step S006 (Step S007).

### (Advantageous Effect)

With the configuration described thus far, when the voice quality of the input speech is converted into the target voice quality, the voice quality conversion can be achieved while maintaining the temporal alteration pattern of the utterance manner of the input speech. As a consequence, since the resultant speech obtained by the voice quality conversion maintains the temporal alteration pattern of the utterance manner of the input speech, the voice quality conversion can be achieved without losing naturalness (i.e., smoothness) in the resultant speech.

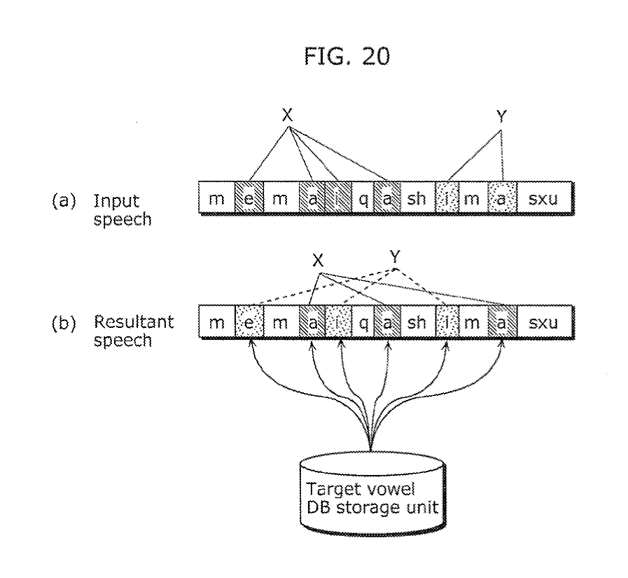

For example, a variation pattern (temporal pattern of distinct or lazy utterance) of the utterance manner (i.e., the clarity) for the vowels included in the input speech as shown in (a) of FIG. 20 becomes identical to a variation pattern of the utterance manner for the speech obtained as a result of the voice quality conversion. Thus, there is no deterioration in voice quality that may be caused due to unnaturalness in the utterance manner of the resultant speech.

Moreover, since the oral cavity volume (namely, the mouth opening degree) corresponding to the vowel sequence included in the input speech is used as a criterion of selecting a target vowel, the amount of vowel information stored in the target vowel DB storage unit 103 can be reduced as compared with the case where various linguistic and physiological conditions are directly considered.

It should be noted that although Embodiment has described the case of speeches in Japanese, the present invention is not limited to the Japanese language. According to the present invention, voice quality conversion can be similarly performed on other languages including English.

For example, compare the following uttered sentences: “Can I make a phone call from this plane?”; and “May I have a thermometer?” Here, /e/ of “plane” at the end of the former sentence is different in the utterance manner from /e/ of “May” at the beginning of the latter sentence. As is the case with Japanese, the utterance manner in English also depends on a position in the uttered speech, whether a content or function word, or the presence or absence of an emphasized word. On account of this, when the target vowel information is selected only based on the phonetic environment, the temporal alteration pattern of the utterance manner is disturbed as in the case of Japanese, which results in deterioration in naturalness of the resultant speech obtained by the voice quality conversion. Hence, by selecting the target vowel information based on the mouth opening degree in the case of the English language as well, the original voice quality can be converted into the target voice quality while the temporal alteration pattern in the utterance manner of the original input speech is maintained. As a consequence, since the resultant speech obtained by the voice quality conversion maintains the temporal alteration pattern of the utterance manner of the input speech, the voice quality conversion can be achieved without losing naturalness (i.e., smoothness) in the resultant speech.

### (Modification 1)

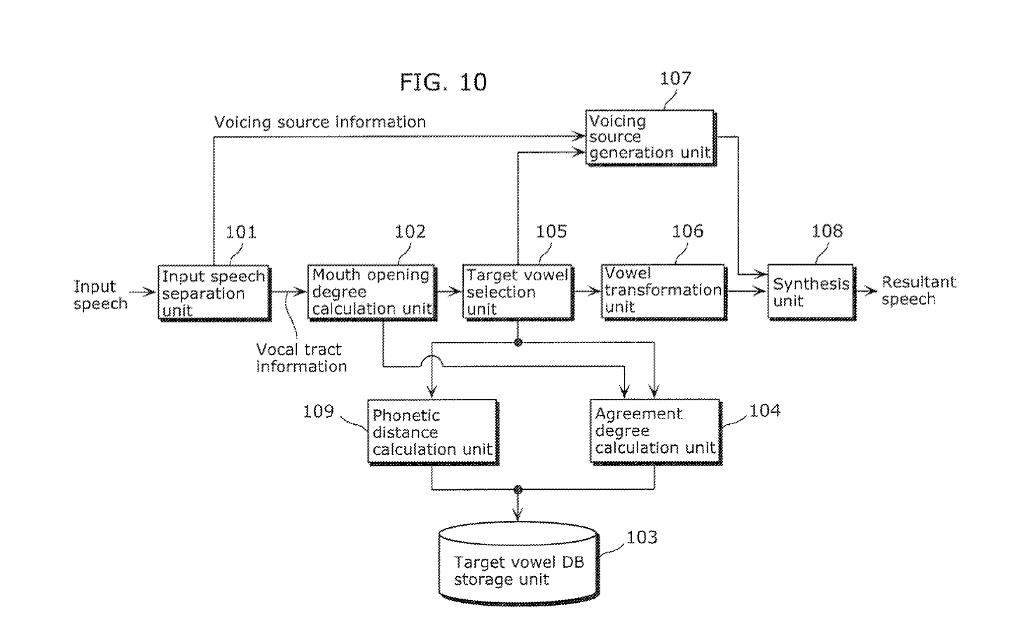

FIG. 10 is a block diagram showing a functional configuration of a voice quality conversion device according to Modification 1 of Embodiment in the present invention. Components shown in FIG. 10 that are identical to those shown in FIG. 2 are assigned the same numerals used in FIG. 2 and, therefore, the explanations of such components are omitted.

Modification 1 is different from Embodiment 1 as follows. The target vowel selection unit 105 selects the target vowel information from the target vowel DB storage unit 103 based not only on the agreement degree calculated by the agreement degree calculation unit 104, but also on a distance, or more specifically, similarity, between the phonetic environment of the vowel included in the input speech and the phonetic environment of the vowel included in the target vowel DB storage unit 103.

In addition to the configuration of the voice quality conversion device shown in FIG. 2, the voice quality conversion device in Modification 1 further includes a phonetic distance calculation unit 109.

### [Phonetic Distance Calculation Unit 109]

The phonetic distance calculation unit 109 shown in FIG. 10 calculates a distance between the phonetic environment of the vowel included in the input speech and the phonetic environment indicated by the vowel information stored in the target vowel DB storage unit 103. Note that the vowels subjected to the calculation between the phonetic environments are of the same type.

More specifically, the phonetic distance calculation unit 109 calculates the distance by verifying the agreement between the preceding and following phoneme types of the original vowel and those of the target vowel.

For example, when the preceding phoneme types do not agree with each other, the phonetic distance calculation unit 109 adds a penalty d to the distance. Similarly, when the following phoneme types do not agree with each other, the phonetic distance calculation unit 109 adds the penalty d to the distance. Here, the penalties d are not necessarily the same value, and a higher priority may be placed on the agreement between the preceding phonemes.

Alternatively, even when the preceding phonemes do not agree with each other, the size of penalty may be changed according to the degree of similarity between the phonemes. For example, when the phonemes belong to the same phoneme category, such as plosive or fricative, the penalty may be set to be smaller. Moreover, when the phonemes are the same in the place of articulation (for an alveolar or palatal sound, for example), the penalty may be set to be smaller.

### [Target Vowel Selection Unit 105]

The target vowel selection unit 105 selects the vowel information from the target vowel DB storage unit 103 for each vowel included in the input speech, based on the agreement degree calculated by the agreement degree calculation unit 104 and on the distance between the phonetic environments calculated by the phonetic distance calculation unit 109.

To be more specific, as expressed by Equation 19, the target vowel selection unit 105 selects, from the target vowel DB storage unit 103, the vowel information on a vowel (j) where a weighted sum of the agreement degree Sᵢⱼ calculated by the agreement degree calculation unit 104 for the vowel sequence included in the input speech and a distance Dᵢⱼ between the phonetic environments calculated by the phonetic distance calculation unit 109 is a minimum.

$$j = {arg min}_{j} [ {S}_{i , j} + w \times {D}_{i , j} ] \qquad [ Equation 19 ]$$

The method of setting a weight w is not particularly limited, and may be determined as appropriate in advance. It should be noted that the weight may be changed according to the size of data stored in the target vowel DB storage unit 103. More specifically, when the pieces of vowel information stored in the target vowel DB storage unit 103 are larger in number, a more weight may be assigned to the distance between the phonetic environments calculated by the phonetic distance calculation unit 109. This is because, when a larger number of pieces of vowel information are stored, a more natural voice quality can be obtained by the conversion by selecting, from among the pieces of vowel information indicating the phonetic environment that agrees with the phonetic environment of the input speech, the vowel information indicating the mouth opening degree that agrees with the mouth opening degree of the input speech. On the other hand, when the pieces of vowel information are small in number, there may be no vowel information indicating the phonetic environment that agrees with the phonetic environment of the input speech. In such a case, unreasonable selection of the vowel information indicating a similar phonetic environment may not lead to the conversion where a more natural voice quality is obtained. That is, conversion into a more natural voice quality can be achieved by preferentially selecting the vowel information indicating the mouth opening degree that agrees with the mouth opening degree of the input speech.

### (Flowchart)

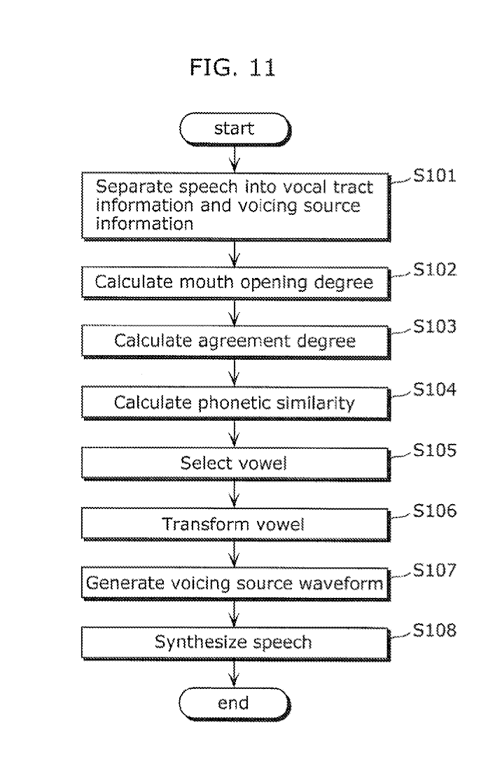

A specific operation performed by the voice quality conversion device in Modification 1 is described, with reference to a flowchart shown in FIG. 11.

The input speech separation unit 101 separates an input speech into vocal tract information and voicing source information (S101). The mouth opening degree calculation unit 102 calculates mouth opening degrees for the vowel sequence included in the input speech, using the vocal tract information separated in Step S101 (S102).

The agreement degree calculation unit 104 calculates a degree of agreement between: the mouth opening degree of a vowel in the vowel sequence of the input speech that is calculated in Step S102; and the mouth opening degree of a target vowel candidate stored in the target vowel DB storage unit 103 (Step S103).

The phonetic distance calculation unit 109 calculates a distance between the phonetic environment of the vowel in the vowel sequence included in the input speech and the phonetic environment of the target vowel candidate stored in the target vowel DB storage unit 103 (Step S104).

The target vowel selection unit 105 selects the target vowel information for each of the vowels in the vowel sequence included in the input speech, based on the agreement degree calculated in Step S103 and the distance between the phonetic environments calculated in Step S104 (Step S105).

The vowel transformation unit 106 transforms the vocal tract information using the target vowel information selected in Step S105, for each of the vowels of the vowel sequence included in the input speech (Step S106).

The voicing source generation unit 107 generates a voicing source waveform using the voicing source information separated from the input speech in Step S101 (Step S107).

The synthesis unit 108 synthesizes a speech using the vocal tract information transformed in Step S106 and the voicing source waveform generated in Step S107 (Step S108).

The processing described thus far can maintain both the phonetic characteristics of the input speech and the temporal alteration pattern of the original utterance manner after the voice quality of the input speech is converted into the target voice quality. As a result, since the phonetic characteristics of the vowels in the input speech and the temporal alteration pattern of the original utterance manner are maintained, the voice quality conversion can be achieved without losing naturalness (i.e., smoothness) in the resultant speech.

Moreover, with this configuration, the voice quality conversion can be achieved without changing the temporal alteration pattern of the utterance manner, by using a small amount of target speech data. Therefore, this configuration is highly useful in various utilization forms. For example, the voice quality of a speech provided by an information technology device in which a plurality of voice messages are stored can be converted into the voice quality of a user by using a short utterance given by the user.

Furthermore, when the target vowel selection unit 105 selects the target vowel information, the weight is adjusted according to the size of data stored in the target vowel DB storage unit 103. More specifically, when the pieces of vowel information stored in the target vowel DB storage unit 103 are larger in number, a more weight is assigned to the distance between the phonetic environments calculated by the phonetic distance calculation unit 109. With this, when the size of data stored in the target vowel DB storage unit 103 is small, a higher priority is given to the agreement between the mouth opening degrees. Thus, even when there is no vowel stored that indicates high similarity in the phonetic environment to the input speech, the target vowel selection unit 105 selects the vowel information indicating the mouth opening degree that highly agrees with the mouth opening degree of the input speech, that is, indicating the utterance manner that agrees with the utterance manner of the input speech. As a consequence, a temporal alteration pattern of an overall natural utterance manner can be reproduced and, therefore, a resultant speech with a high degree of naturalness can be obtained by the voice quality conversion.

When the size of data stored in the target vowel DB storage unit 103 is large, the vowel information on the target vowel is selected in consideration of both the distance between the phonetic environments as and the degree of agreement between the mouth opening degrees. Thus, the mouth opening degree can be further considered in addition to the consideration given to the phonetic environment. As a result, as compared with the conventional case where the vowel information is selected only based on the phonetic environment, the temporal alteration pattern of a more natural utterance manner can be reproduced and, therefore, a resultant speech with a high degree of naturalness can be obtained by the voice quality conversion.

### (Modification 2)

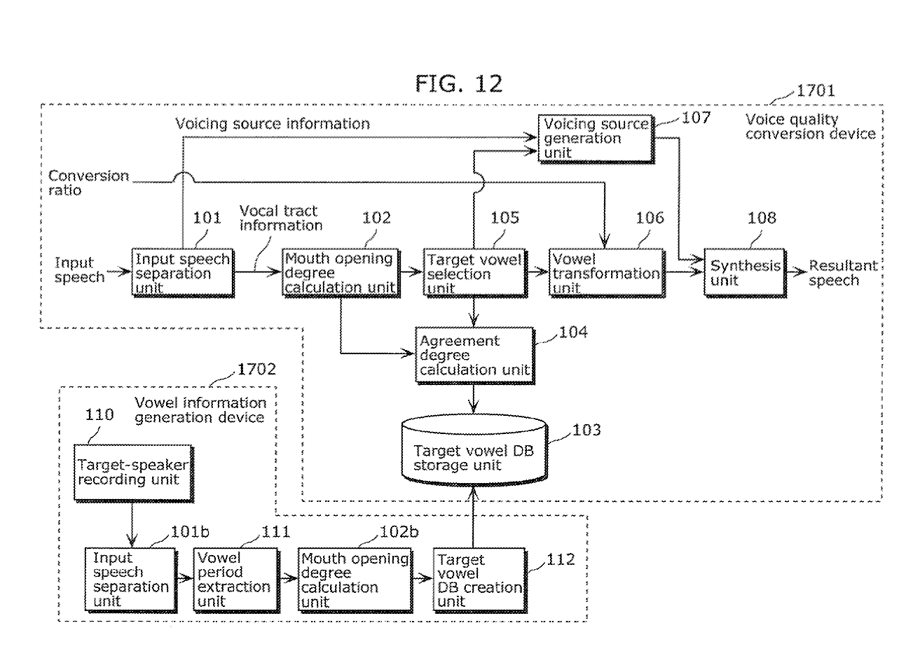

FIG. 12 is a block diagram showing a functional configuration of to a voice quality conversion system according to Modification 2 of Embodiment in the present invention. Components shown in FIG. 12 that are identical to those shown in FIG. 2 are assigned the same numerals used in FIG. 2 and, therefore, the explanations of such components are omitted.

The voice quality conversion system includes a voice quality conversion device 1701 and a vowel information generation device 1702. The voice quality conversion device 1701 and the vowel information generation device 1702 may be directly linked via a wired or wireless connection or via a network such as the Internet or a local area network (LAN).

The voice quality conversion device 1701 has the same configuration as the voice quality conversion device shown in FIG. 2 in Embodiment.

The vowel information generation device 1702 includes a target-speaker recording unit 110, an input speech separation unit 101b, a vowel period extraction unit 111, a mouth opening degree calculation unit 102b, and a target vowel DB creation unit 112. It should be noted that essential components in the vowel information generation device 1702 is the input speech separation unit 101b, the mouth opening degree calculation unit 102b, and the target vowel DB creation unit 112.

The target-speaker recording unit 110 records a speech having several sentences to several tens of sentences. The vowel period extraction unit 111 extracts a vowel period from the recorded speech. The target vowel DB creation unit 112 generates vowel information using the speech of the target speaker recorded by the target-speaker recording unit 110, and then stores the vowel information into the target vowel DB storage unit 103.

The input speech separation unit 101b and the mouth opening degree calculation unit 102b have the same configurations as the input speech separation unit 101 and the mouth opening degree calculation unit 102 shown in FIG. 2, respectively. Therefore, the detailed explanations of these units are not repeated here.

A method of generating the vowel information to be stored in in the target vowel DB storage unit 103 is described, with reference to the flowchart shown in FIG. 5.

A speaker having a target voice quality is asked to utter sentences, and the target-speaker recording unit 110 records these sentences as a sentence set (Step S101). Although the number of sentences is not limited, a speech having several sentences to several tens of sentences is recorded. The target-speaker recording unit 110 records the speech so that at least two utterances are obtained for one type of vowel.

The input speech separation unit 101b separates the speech of the recorded sentence set into the vocal tract information and the voicing source information (Step S102).

The vowel period extraction unit 111 extracts a period corresponding to a vowel from the vocal tract information separated in Step S102 (Step S103). The extraction method is not particularly limited. For example, the vowel period may be automatically extracted by an automatic labeling method.

The mouth opening degree calculation unit 102b calculates the mouth opening degree for each vowel period extracted in Step S103. Here, the mouth opening degree calculation unit 102b performs the calculation to obtain the mouth opening degree in the central area of the extracted vowel period. It should be obvious that it is not limited to the central area, and that all the characteristics during the vowel period may be calculated or that an average value of the mouth opening degrees of the vowel period may be calculated. Alternatively, as a median value of the mouth opening degrees in the vowel period may be calculated.

The target vowel DB creation unit 112 enters, for each of the vowels, the mouth opening degree of the vowel calculated in Step S104 and information used for voice quality conversion are entered as the vowel information into the target vowel DB storage unit 103 (Step S105). More specifically, as shown in FIG. 6, the vowel information includes: a vowel number for identifying the vowel information; a type of vowel; PARCOR coefficients representing the vocal tract information in the vowel period; a mouth opening degree; a phonetic environment of the vowel (such as information on preceding and following phonemes, information on preceding and following syllables, or articulation points of the preceding and following phonemes); the voicing source information in the vowel period (such as a spectral tilt and a glottal open quotient OQ); and prosodic information (such as a fundamental frequency and power).

By the processing described thus far, the vowel information generation device can record the speech of the target speaker and generate the vowel information to be stored into the target vowel DB storage unit 103. This allows the target voice quality to be updated whenever necessary.

Using the target vowel DB storage unit 103 configured as described above, both the phonetic characteristics of the input speech and the temporal alteration pattern of the original utterance manner are maintained after the voice quality of the input speech is converted into the target voice quality. As a result, since the phonetic characteristics of the vowels in the input speech and the temporal alteration pattern of the original utterance manner are maintained, the voice quality conversion can be achieved without losing naturalness (i.e., smoothness) in the resultant speech.

It should be noted that the voice quality conversion device 1701 and the vowel information generation device 1702 are provided in the same device. In such a case, the input speech separation unit 101b may be designed to use the input speech separation unit 101 and, similarly, the mouth opening degree calculation unit 102b may be designed to use the mouth opening degree calculation unit 102.

Note that the following are the components required at the minimum to implement an aspect in the present invention.

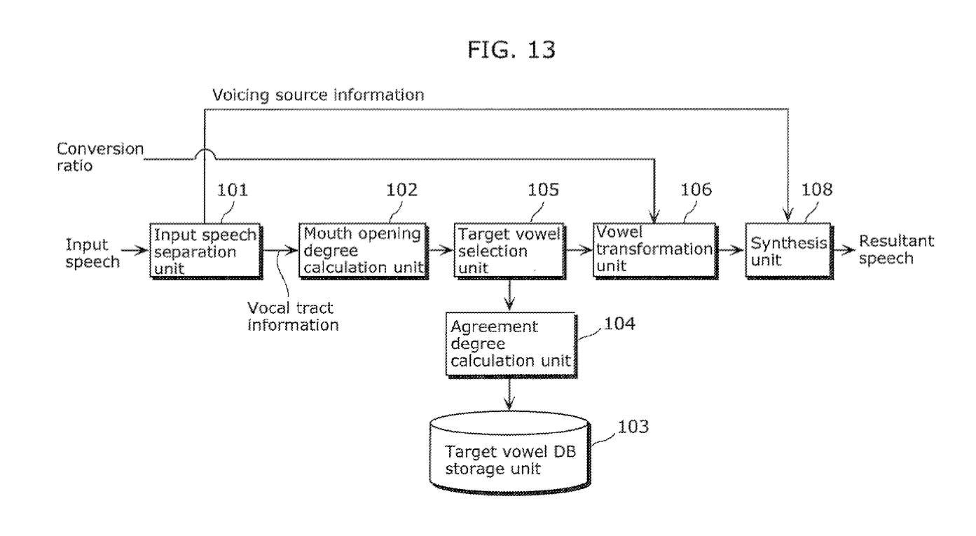

FIG. 13 is a block diagram showing a minimum configuration of a voice quality conversion device for implementing an aspect in the present invention. In FIG. 13, the voice quality conversion device includes an input speech separation unit 101, a mouth opening degree calculation unit 102, a target vowel DB storage unit 103, an agreement degree calculation unit 104, a target vowel selection unit 105, a vowel transformation unit 106, and a synthesis unit 108. That is, this configuration is identical to the configuration shown in FIG. 2 except that the voicing source generation unit 107 is not included. The synthesis unit 108 in the voice quality conversion device shown in FIG. 13 synthesizes the speech using the voicing source information separated by the input speech separation unit, instead of using the voicing source information generated by the voicing source generation unit 107. More specifically, the voicing source information used for speech synthesis is not particularly limited in the present invention.

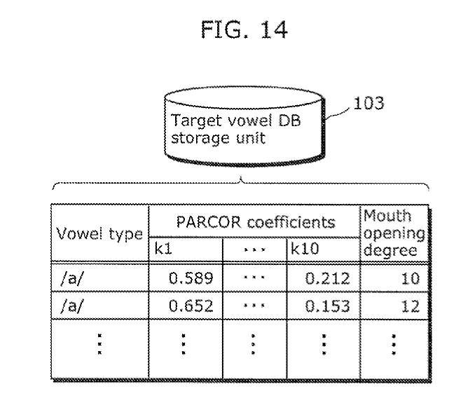

FIG. 14 is a diagram showing a minimum configuration of the vowel information stored in the target vowel DB storage unit 103. The vowel information includes a type of vowel, vocal tract information (PARCOR coefficient), and a mouth opening degree. Using this vowel information, the vocal tract information can be selected based on the mouth opening degree and the vocal tract information can be accordingly transformed.

When the vocal tract information on the vowel is appropriately selected based on the mouth opening degree and then the voice quality of the input speech is to be converted into the target voice quality, the voice quality conversion can be achieved while maintaining the temporal alteration pattern of the utterance manner of the input speech. As a consequence, since the resultant speech obtained by the voice quality conversion maintains the temporal alteration pattern of the utterance manner of the input speech, the voice quality conversion can be achieved without losing naturalness (i.e., smoothness) in the resultant speech.

It should be noted that the target vowel DB storage unit 103 may be provided outside the voice quality conversion device. In such a case, the target vowel DB storage unit 103 is not an essential component of the voice quality conversion device.

Although the voice quality conversion device and the voice quality conversion system have been described based on Embodiment according to the present invention, the present invention is not limited to Embodiment described above.

For example, each of the voice quality conversion devices described in Embodiment and Modifications above can be to implemented by a computer.

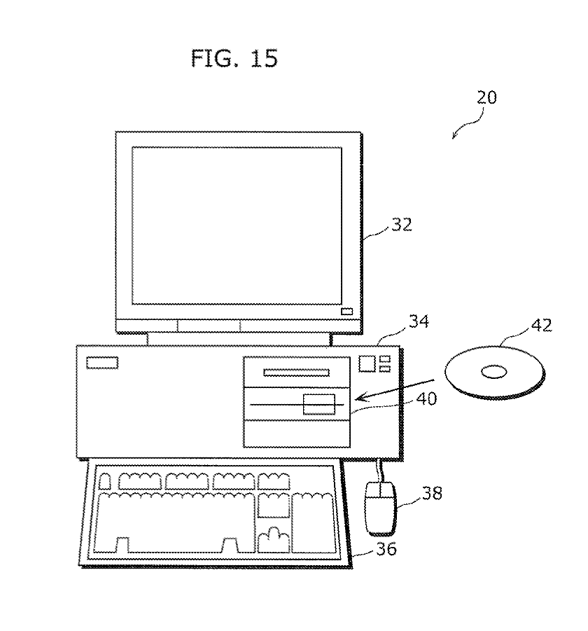

FIG. 15 shows an external view of a voice quality conversion device 20. The voice quality conversion device 20 includes: a computer 34; a keyboard 36 and a mouse 38 for giving instructions to the computer 34; a display 32 for presenting information such as a result of a computation executed by the computer 34; and a compact disc-read only memory (CD-ROM) device 40 and a communication modem (not illustrated) for reading a program to be executed by the computer 34.

A program used for implementing voice quality conversion is stored in a CD-ROM 42 which is a computer-readable recording medium. This program is read by the CD-ROM device 40, or by the communication modem via a computer network 26.

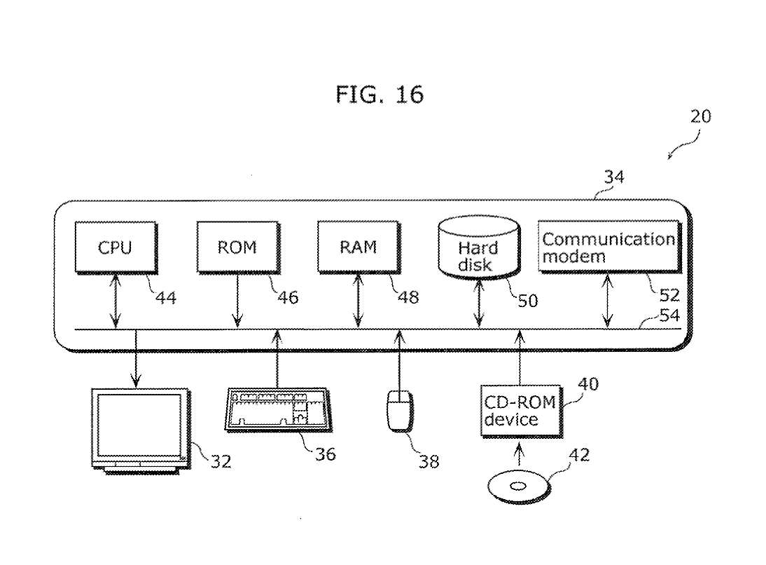

FIG. 16 is a block diagram showing a hardware configuration of the voice quality conversion device 20. The computer 34 includes a central processing unit (CPU) 44, a read only memory (ROM) 46, a random access memory (RAM) 48, a hard disk 50, a communication modem 52, and a bus 54.

The CPU 44 executes a program read by the CD-ROM device 40 or via the communication modem 52. The ROM 46 stores a program or data required for an operation performed by the computer 34. The RAM 48 stores data, such as a parameter used when the program is executed. The hard disk 50 stores a program and data, for example. The communication modem 52 establishes communications with another computer via the computer network 26. The bus 54 interconnects the CPU 44, the ROM 46, the RAM 48, the hard disk 50, the communication modem 52, the display 32, the keyboard 36, the mouse 38, and the CD-ROM device 40.

It should be noted that the vowel information generation device can be similarly implemented by a computer as well.

Moreover, some or all of the components included in each of the above-described devices may be realized as a single system Large Scale Integration (LSI). The system LSI is a super multifunctional LSI manufactured by integrating a plurality of components onto a signal chip. To be more specific, the system LSI is a computer system configured with a microprocessor, a ROM, a RAM, and so forth. The RAM stores a computer program. The microprocessor operates according to the computer program, so that a function of the system LSI is carried out.

Furthermore, some or all of the components included in each of the above-described devices may be implemented as an IC card or a standalone module that can be inserted into and removed from the corresponding device. The IC card or the module is a computer system configured with a microprocessor, a ROM, a RAM, and so forth. The IC card or the module may include the aforementioned super multifunctional LSI. The microprocessor operates according to the computer program, so that a function of the IC card or the module is carried out. The IC card or the module may be tamper resistant.

Moreover, the present invention may be the methods described above. Each of the methods may be a computer program implemented by a computer, or may be a digital signal of the computer program.

Furthermore, the present invention may be the aforementioned computer program or digital signal recorded on a computer-readable nonvolatile recording medium, such as a flexible disk, a hard disk, a CD-ROM, an MO, a DVD, a DVD-ROM, a DVD-RAM, a Blu-ray Disc (BD) (registered trademark), or a semiconductor memory. Also, the present invention may be the digital signal recorded on such a recording medium.

Moreover, the present invention may be the aforementioned computer program or digital signal transmitted via a telecommunication line, a wireless or wired communication line, a network represented by the Internet, and data broadcasting.

Furthermore, the present invention may be a computer system including a microprocessor and a memory. The memory may store the aforementioned computer program and the microprocessor may operate according to the computer program.

Moreover, by transferring the nonvolatile recording medium having the aforementioned program or digital signal recorded thereon or by transferring the aforementioned program or digital signal via the aforementioned network or the like, the present invention may be implemented by a different independent computer system.

Furthermore, Embodiment and Modifications described above may be combined.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The voice quality conversion device in an aspect of the present invention has a function of converting voice quality of an input speech into a target voice quality while maintaining a temporal alteration pattern of an utterance manner of the input speech. Thus, the voice quality conversion device is useful to an information technology device or a user interface of a home electric apparatus which require various voice qualities, or to an entertainment use such as ring tone creation by custom voice-quality conversion for a user. Moreover, the voice quality conversion device can be applied to, for example, a voice changer used in speech communication via a mobile telephone or the like.

1. A voice quality conversion device which converts voice quality of an input speech, said voice quality conversion device comprising:
an input speech separation unit configured to separate the input speech into vocal tract information and voicing source information;
a mouth opening degree calculation unit configured to calculate a mouth opening degree corresponding to an oral cavity volume, from the vocal tract information on a vowel included in the input speech separated by said input speech separation unit;
a target vowel database storage unit in which a plurality of pieces of vowel information on a target voice quality to be used for converting the voice quality of the input speech are stored, each of the pieces of vowel information including (i) information on a type of a vowel and on a mouth opening degree of the vowel and (ii) vocal tract information;
an agreement degree calculation unit configured to calculate a degree of agreement between the mouth opening degree calculated by said mouth opening degree calculation unit and the mouth opening degree included in the vowel information stored in said target vowel database storage unit, the vowels subjected to the calculation being of a same type between the mouth opening degrees;
a target vowel selection unit configured to select the vowel information from among the pieces of vowel information stored in said target vowel database storage unit, based on the agreement degree calculated by said agreement degree calculation unit;
a vowel transformation unit configured to transform the vocal tract information on the vowel included in the input speech, using the vocal tract information included in the vowel information selected by said target vowel selection unit; and
a synthesis unit configured to generate a synthetic speech, using the transformed vocal tract information on the input speech obtained by said vowel transformation unit and the voicing source information separated by said input speech separation unit.

2. The voice quality conversion device according to claim 1,
wherein said mouth opening degree corresponding to an oral cavity volume is a sum of vocal tract cross-sectional areas.

3. The voice quality conversion device according to claim 1,
wherein said target vowel selection unit is configured to select the vowel information including the mouth opening degree that agrees most with the mouth opening degree of the vowel included in the input speech, from among the pieces of vowel information stored in said target vowel database storage unit, based on the agreement degree calculated by said agreement degree calculation unit.

4. The voice quality conversion device according to claim 1,
wherein each of the pieces of vowel information further includes information on a phonetic environment of the vowel,
said voice quality conversion device further comprises
a phonetic distance calculation unit configured to calculate a distance indicating similarity between a phonetic environment of the vowel included in the input speech and the phonetic environment included in the vowel information stored in said target vowel database storage unit, the vowels subjected to the calculation being of a same type between the phonetic environments, and
said target vowel selection unit is configured to select the vowel information used for transforming the vocal tract information on the vowel included in the input speech, from among the pieces of vowel information stored in said target vowel database storage unit, based on the agreement degree calculated by said agreement degree calculation unit and the distance calculated by said phonetic distance calculation unit.

5. The voice quality conversion device according to claim 4,
wherein said target vowel selection unit is configured to:
assign a more weight to the distance calculated by said phonetic distance calculation unit corresponding to the agreement degree calculated by said agreement degree calculation unit, when the pieces of vowel information stored in said target vowel database storage unit are larger in number; and
select the vowel information used for transforming the vocal tract information on the vowel included in the input speech, from among the pieces of vowel information stored in said target vowel database storage unit, based on the weighted distance and the weighted agreement degree.

6. The voice quality conversion device according to claim 1,
wherein said mouth opening degree calculation unit is configured to calculate a vocal tract cross-sectional area function from the vocal tract information on the vowel included in the input speech separated by said input speech separation unit, and to calculate, as the mouth opening degree, a sum of vocal tract cross-sectional areas indicated by the calculated vocal tract cross-sectional area function.

7. The voice quality conversion device according to claim 6,
wherein said mouth opening degree calculation unit is configured to calculate the vocal tract cross-sectional area function from the vocal tract information on the vowel included in the input speech separated by said input speech separation unit, and to calculate, as the mouth opening degree of when a vocal tract area is divided into a plurality of sections, a sum of vocal tract cross-sectional areas corresponding to the sections indicated by the calculated vocal tract cross-sectional area function.

8. The voice quality conversion device according to claim 1,
wherein said agreement degree calculation unit is configured to normalize, for each of an original speaker of the input speech and a target speaker having the target voice quality, the mouth opening degree calculated by said mouth opening degree calculation unit and the mouth opening degree included in the vowel information stored in said target vowel database storage unit, and to calculate, as the agreement degree, a degree of agreement between the normalized mouth opening degrees, the vowels subjected to the normalization being of a same type between the mouth opening degrees.

9. The voice quality conversion device according to claim 1,
wherein said agreement degree calculation unit is configured to normalize, for each vowel type, the mouth opening degree calculated by said mouth opening degree calculation unit and the mouth opening degree included in the vowel information stored in said target vowel database storage unit, and to calculate, as the agreement degree, a degree of agreement between the normalized mouth opening degrees, the vowels subjected to the normalization being of a same type between the mouth opening degrees.

10. The voice quality conversion device according to claim 1,
wherein said agreement degree calculation unit is configured to calculate, as the agreement degree, a degree of agreement between a difference in the mouth opening degree in a temporal direction calculated by said mouth opening degree calculation unit and a difference in the mouth opening degree in the temporal direction included in the vowel information stored in said target vowel database storage unit, the vowels subjected to the calculation being of a same type between the mouth opening degrees.

11. The voice quality conversion device according to claim 1,
wherein said vowel transformation unit is configured to transform the vocal tract information on the vowel included in the input speech into the vocal tract information included in the vowel information selected by said target vowel selection unit, at a predetermined conversion ratio.

12. A voice quality conversion device which converts voice quality of an input speech, said voice quality conversion device comprising:
an input speech separation unit configured to separate the input speech into vocal tract information and voicing source information;
a mouth opening degree calculation unit configured to calculate a mouth opening degree corresponding to an oral cavity volume, from the vocal tract information on a vowel included in the input speech separated by said input speech separation unit;
an agreement degree calculation unit configured to reference to a plurality of pieces of vowel information, stored in a target vowel database storage unit, on a target voice quality to be used for converting the voice quality of the input speech, each of the pieces of vowel information including (i) information on a type of a vowel and on a mouth opening degree of the vowel and (ii) vocal tract information, to calculate a degree of agreement between the mouth opening degree calculated by said mouth opening degree calculation unit and the mouth opening degree included in the vowel information stored in said target vowel database storage unit, the vowels subjected to the calculation being of a same type between the mouth opening degrees;
a target vowel selection unit configured to select the vowel information from among the pieces of vowel information stored in said target vowel database storage unit, based on the agreement degree calculated by said agreement degree calculation unit;
a vowel transformation unit configured to transform the vocal tract information on the vowel included in the input speech, using the vocal tract information included in the vowel information selected by said target vowel selection unit; and
a synthesis unit configured to generate a synthetic speech, using the transformed vocal tract information on the input speech obtained by said vowel transformation unit and the voicing source information separated by said input speech separation unit.

13. A vowel information generation device which generates vowel information on a target speaker having a target voice quality to be used for converting voice quality of an input speech, said vowel information generation device comprising:
an input speech separation unit configured to separate a speech of the target speaker into vocal tract information and voicing source information;
a mouth opening degree calculation unit configured to calculate a mouth opening degree corresponding to an oral cavity volume, from the vocal tract information on the speech of the target speaker separated by said input speech separation unit; and
a target vowel information generation unit configured to generate vowel information on the target speaker, the vowel information including (i) information on a vowel type and on the mouth opening degree calculated by said mouth opening degree calculation unit and (ii) the vocal tract information separated by said input speech separation unit.

14. A voice quality conversion system comprising
the voice quality conversion device according to claim 1; and
a vowel information generation device which generates vowel information on a target speaker having a target voice quality to be used for converting voice quality of an input speech, said vowel information generation device comprising:
an input speech separation unit configured to separate a speech of the target speaker into vocal tract information and voicing source information;
a mouth opening degree calculation unit configured to calculate a mouth opening degree corresponding to an oral cavity volume, from the vocal tract information on the speech of the target speaker separated by said input speech separation unit; and
a target vowel information generation unit configured to generate vowel information on the target speaker, the vowel information including (i) information on a vowel type and on the mouth opening degree calculated by said mouth opening degree calculation unit and (ii) the vocal tract information separated by said input speech separation unit.

15. A voice quality conversion method of converting voice quality of an input speech, said voice quality conversion method comprising:
separating the input speech into vocal tract information and voicing source information;
calculating a mouth opening degree corresponding to an oral cavity volume, from the vocal tract information on a vowel included in the input speech separated in said separating;
calculating a degree of agreement between the mouth opening degree calculated in said calculating of a mouth opening degree and a mouth opening degree included in vowel information stored in the target vowel database storage unit in which a plurality of pieces of vowel information on a target voice quality to be used for converting the voice quality of the input speech are stored, each of the pieces of vowel information including (i) information on a type of a vowel and on the mouth opening degree of the vowel and (ii) vocal tract information, the vowels subjected to said calculating of a degree of agreement being of a same type;
selecting the vowel information to be used for converting the vocal tract information on the vowel included in the input speech, from among the pieces of vowel information stored in the target vowel database storage unit, based on the agreement degree calculated in said calculating of a degree of agreement;
transforming the vocal tract information on the vowel included in the input speech, using the vocal tract information included in the vowel information selected in said selecting; and
generating a synthetic speech, using the transformed vocal tract information on the input speech obtained in said transforming and the voicing source information separated in said separating.

16. The voice quality conversion method according to claim 15,
wherein, in said selecting, the vowel information including the mouth opening degree that agrees most with the mouth opening degree of the vowel included in the input speech is selected from among the pieces of vowel information stored in the target vowel database storage unit, based on the agreement degree calculated in said calculating of an agreement degree.

17. A non-transitory computer-readable recording medium for use in a computer, the recording medium having recorded thereon a computer program for converting voice quality of an input speech, the computer including a target vowel database storage unit in which a plurality of pieces of vowel information are stored, each of the pieces including information on a vowel type and on a mouth opening degree and vocal tract information, and the computer program, when loaded onto the computer, causing the computer to execute:
separating the input speech into vocal tract information and voicing source information;
calculating a mouth opening degree corresponding to an oral cavity volume, from the vocal tract information on a vowel included in the input speech separated in said separating;
calculating a degree of agreement between the mouth opening degree calculated in said calculating of a mouth opening degree and the mouth opening degree included in the vowel information, stored in the target vowel database storage unit, on a target voice quality to be used for converting the voice quality of the input speech, the vowels subjected to said calculating of a degree of agreement being of a same type;
selecting the vowel information from among the pieces of vowel information stored in the target vowel database storage unit, based on the agreement degree calculated in said calculating of a degree of agreement;
transforming the vocal tract information on the vowel included in the input speech, using the vocal tract information included in the vowel information selected in said selecting; and
generating a synthetic speech, using the transformed vocal tract information on the input speech obtained in said transforming and the voicing source information separated in said separating.
